(19) United States
(12) Patent Application Publication
(10) Pub. No.: US 2024/0370393 A1
(43) Pub. Date: Nov. 7, 2024

(54) Management of Memory Access to Reduce Impacts of Direct Memory Access Latency

(71) Applicant: Micron Technology, Inc., Boise, ID (US)

(72) Inventors: Saideep Tiku, Folsom, CA (US); Febin Sunny, Folsom, CA (US); Poorna Kale, Folsom, CA (US)

(21) Appl. No.: 18/604,318

(22) Filed: Mar. 13, 2024

Related U.S. Application Data
(60) Provisional application No. 63/499,917, filed on May 3, 2023.

(51) Int. Cl. G06F 13/28; G06F 3/06

(52) U.S. Cl. CPC G06F 13/28; G06F 3/0611; G06F 3/0655; G06F 3/0679; G06F 2213/28

(57) ABSTRACT

A computing system having a photonic interconnect configured between a memory sub-system having a plurality of memory islands and a host system running one or more applications using memory provide by an active subset of the memory islands. The memory sub-system includes a direct memory access controller operable to transfer data between the other memory islands of the memory sub-system, while the host system runs on the active subset. The photonic interconnect can be configured to distribute its communication bandwidth to the active subset without being effected by the direct memory access operations performed on memory islands outside of the active subset.

### RELATED APPLICATIONS

The present application claims priority to Prov. U.S. Pat. App. Ser. No. 63/499,917 filed May 3, 2023, the entire disclosures of which application are hereby incorporated herein by reference.

### TECHNICAL FIELD

At least some embodiments disclosed herein relate to memory access in general and more particularly, but not limited to, memory access via optical connections.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows a system configured with systolic memory access according to one embodiment.

FIG. 2 shows a memory sub-system configured to facilitate systolic memory access according to one embodiment.

FIG. 3 shows a processor sub-system configured to facilitate systolic memory access according to one embodiment.

FIG. 4 shows an optical interface circuit operable in a system of systolic memory access according to one embodiment.

FIG. 5 shows an optical interface module according to one embodiment.

FIG. 6 shows a configuration to connect a memory sub-system and a processor sub-system according to one embodiment.

FIG. 7 shows a configuration to connect memory sub-systems and a processor sub-system for systolic memory access according to one embodiment.

FIG. 8 and FIG. 9 show techniques to connect a logic die to a printed circuit board and an optical fiber according to one embodiment.

FIG. 10 shows a technique to use a compiler to configure the operations of systolic memory access according to one embodiment.

FIG. 11 shows a memory sub-system configured to provide a host system with access to a data store according to one embodiment.

FIG. 12 and FIG. 13 illustrate direct memory access operations of a memory sub-system according to one embodiment.

FIG. 14 shows a photonic interconnect system configured between a host system and a direct memory access controller according to one embodiment.

FIG. 15 and FIG. 16 illustrate the operations of the photonic interconnect system of FIG. 14 during direct memory access according to one embodiment.

FIG. 17 shows a method of memory access management according to some embodiments.

### DETAILED DESCRIPTION

At least some embodiments disclosed herein provide techniques for a host system to run high performance computing applications using data in a data store accessible via direct memory access (DMA) and a high bandwidth memory (HBM).

For example, direct memory access (DMA) can be used to pre-load data from the data store into the high bandwidth memory (HBM). A host system can be connected to the high bandwidth memory (HBM) via a high bandwidth interconnect, such as a photonic interconnect to access the memory capacity of the high bandwidth memory (HBM), including the pre-loaded data. Once the pre-loaded data is in the high bandwidth memory, the high bandwidth interconnect allows the host system to access the data in the high bandwidth memory (HBM) at a high speed with low latency. During the processing of the pre-loaded data, the applications running in the host system can use the memory capacity of the high bandwidth memory (HBM) to store and retrieve intermediate results. After the completion of the processing of the pre-loaded data, the application running in the host system can store, over the high bandwidth interconnect, the output of the processing into the high bandwidth memory (HBM) at a high speed with low latency. Subsequently, direct memory access (DMA) can be used to offload the output from the high bandwidth memory (HBM) to the data store.

There can be a significant latency in direct memory access (DMA) operations of loading inputs from the data store and offloading outputs into the data store. To reduce or eliminate the impact of the direct memory access (DMA) latency on the computing performance of the host system, the high bandwidth memory (HBM) can be configured to have a plurality of memory islands, each operable independent from other memory islands. Each memory island is operable to dynamically replace another memory island in the high bandwidth memory (HBM).

The memory islands can be dynamically partitioned or grouped into two subsets. One subset of the memory islands is connected via the high bandwidth interconnect to the host system to provide memory services in running the applications at the current stage. The entire bandwidth of the interconnect configured between the host system and the high bandwidth memory (HBM) can be used by the host system to access memory services provided via the memory islands in the subset.

While the host system runs applications using the subset of the memory islands that are connected to the host system via the high bandwidth interconnect, a direct memory access (DMA) controller can be instructed to control the other subset of the memory islands to transfer data to and/or from the data store. The direct memory access (DMA) controller and the host system can concurrently operate on the two separate subsets of memory islands for a period of time without interference with each other.

When the direct memory access (DMA) controller completes its operations with a memory island, the memory island can be dynamically connected by the interconnect system to the host system and thus join the subset controlled by the host system for running applications. When the memory island is connected to the host system, the pre-loaded data in the memory island can be used by the host system immediately.

When the host system completes its operations with a memory island, the memory island can be dynamically disconnected by the interconnect system from the host system and thus join the subset controlled by the direct memory access (DMA) controller for data transferring to or from the data store. When the memory island is disconnected from the host system, the outputs generated by the host system in the memory island can be offloaded to the data store by the direct memory access (DMA) controller; and further inputs can be loaded from the data stored into the memory island.

Since the direct memory access (DMA) operations are configured and scheduled to be performed on a memory island during the time period in which the host system uses other memory islands, the direct memory access (DMA) latency has reduced or no impact on the performance of the applications running in the host system.

For example, many scientific applications in the high performance computing (HPC) domain (e.g., weather simulation, astrophysics, computational fluid dynamics, etc.) have heavily parallelizable portions in terms of compute and memory. These applications can require large amounts of data (e.g., terabytes) to be moved, a portion at a time, between storage and working memory. Further, these applications can lack significant procedural dependency across the partial outputs/results generated by such routines (e.g., unlike deep learning workloads).

Due to the highly distributed nature of such applications, fabric attached storage can be employed to store data used by the applications; and the data to be processed at a given processing element can be moved into the working memory on demand. A photonic interconnect can be used to move data between memories and processing elements in the host system to meet the memory bandwidth demands of the applications.

Instead of configuring a dedicated memory (or a set of dedicated memory modules) for each processing element, a large number of memory islands can be configured to provide memory services to a collection of processing elements in the host system. The memory islands can be accessible to the processing elements over a photonic interconnect according to a protocol of computer express link (CXL). The photonic interconnect can be implemented at least in part via a photonic switch.

For example, the large amount of data being read from the fabric attached storage can be pre-chunked and loaded into the next memory island while the processing elements are still working with the data in the previous memory island(s). Thus, the latencies associated with moving data from the network/fabric attached storage can be at least partially hidden from the computing elements. The applications running in the host system can have a performance level that is substantially the same as implementing the data store in the high bandwidth memory (HBM).

Optionally, the photonic interconnect can be configured to implement memory virtualization such that the memory addresses used by the processing elements are independent on the actual memory islands from which memory resources are allocated for the processing elements. For example, to reduce latency of access while considering the application bandwidth requirements, a memory virtualization technique (e.g., Knapsack algorithm) that factors in ping latency and high bandwidth memory (HBM) throughput can be utilized.

Optionally, the photonic interconnect can be configured to dynamically connect, using virtual channels implemented using optical signals of different wavelengths, the host system to a subset of memory islands that are currently assigned to the host system to run applications. The photonic interconnect can facilitate high speed data transfer, with minimal energy consumption. Photonic communication channels of different wavelengths can be selected and configured, through a photonic switch, between the host system and the respective memory islands being accessed by the host system. For example, the photonic switch can be implemented via arrayed waveguide grating (AWG) based photonic multiplexers.

Optionally, arrayed waveguide grating (AWG) based photonic switching can be used to passively address the memory islands in the high bandwidth memory currently assigned to run the applications in the host system.

For example, transmissions of optical signals of a particular wavelength can be used for the host system in addressing memory accesses mapped to a particular memory island; and the optical signals can be routed via the photonic switch to the memory controller of the memory island having a section of memory being mapped to the memory addresses being accessed. Thus, the memory access can be dynamically mapped to the particular memory island, instead of to other memory islands. For example, virtual memory addressing can be used to implement the address space resolution and lump together the address ranges across memory islands currently assigned for a host system running the applications.

Optionally, a large number of dynamic random access memory (DRAM) chips can be configured in a memory sub-system for systolic memory access where data is configured to flow between two memory sub-systems through a processor sub-system in directions predetermined for clock cycles. The processor sub-system is configured to operate on the data flowing between the memory sub-systems.

Due to the increasing demands from modern processing units and applications, orchestrating data movement to and from processing elements and memory has become an important consideration to be made in system design. To address the above and other challenges and deficiencies, systolic memory access assisted by high-bandwidth, wavelength division multiplexing (WDM) based photonic bandwidths can be used. High bandwidth photonic interconnects are be configured to connect disaggregated memory and compute banks.

The systolic memory access pattern can efficiently utilize the high bandwidth offered by wavelength division multiplexing (WDM) based photonic interconnects, with minimal buffering and associated latency. The systolic flow of access and hence data also facilitates lower hardware cost. Photonic links do not support duplex communication over a same waveguide/optical fiber. A typical usual solution is to double the number of optical fibers/waveguides to facilitate duplex communications over separate waveguides/optical fibers. The systolic memory access pattern avoids such a communication pattern.

In one embodiment, two photonic interconnect-enabled memory banks are separately connected to a single bank of high performance computing elements. For example, each of the memory banks can be configured with an optical interface circuit (OIC) that provides a port for a connection to a ribbon of one or more optical fibers. The bank of computing elements can have two optical interface circuits for connections with the memory banks respectively with ribbons of optical fibers. Data is configured to flow from one memory bank toward another memory bank, through the computing element bank in one cycle; and data is configured to flow in the opposite direct in another cycle.

Such data flow techniques can be well suited for certain applications that have predictable and systematic read/write patterns. Examples of such applications include deep learning inference based on very large models (e.g., bidirectional encoder representations from transformers (BERT) with large models).

For example, a memory sub-system to implement systolic memory access can have a plurality of high bandwidth memory (HBM) devices. Each HBM device has a set of random access memories (e.g., dynamic random access memory (DRAM) chips) managed by a single memory controller. The memory controllers of the HBM devices of the memory sub-system are connected via electrical interconnects to a central optical interface circuit that can transmit or receive data over an optical fiber ribbon.

For example, the bank of processing elements can have a collection of interconnected server-scale processors. The processors can be tasked with various parts of the inference task graph, and can pass results of computation operations from one processor to next. A free processor in the bank can be fed the next set of data buffered in the optical interface circuits (e.g., next set of the data in the same batch) as soon as it is done with its assigned processing of task graphs.

For example, an optical interface circuit can be an electro-optical circuit, which includes buffering circuits and the optical transmission and reception circuits. For example, microring resonators controlled by tuning circuits can be used in transmission circuits to modulate optical signals in a waveguide to transmit data; and optical signals in microring resonators coupled to a waveguide can be measured via photodetectors in reception circuits to identify received data.

The systolic data movement allows for quick data movement from a memory bank to a processing element bank and to another memory bank. To facilitate the systolic data movement, the data involved in the operations are defined and organized for easy access via a static memory mapping scheme that can be determined through address assignments at a compiler level.

For example, the compiler can be provided with an internal mapping of the systolic memory access system along with a transaction level model (TLM) of system. Based on the transaction level model the compiler can be configured to identify the read and write latency tolerances and decide how to map and extract data for a given application using systolic data movements.

For example, a typical inference acceleration application has a predictable data footprint, which allows the compiler to determine a valid static data mapping and a read and write schedule for accessing the high bandwidth memory devices.

To map data placements, the compiler can utilize a memory virtualizer and consider the memory array as a contiguous memory space in assisting the generation of physical addresses needed across multiple high bandwidth memory (HBM) chips.

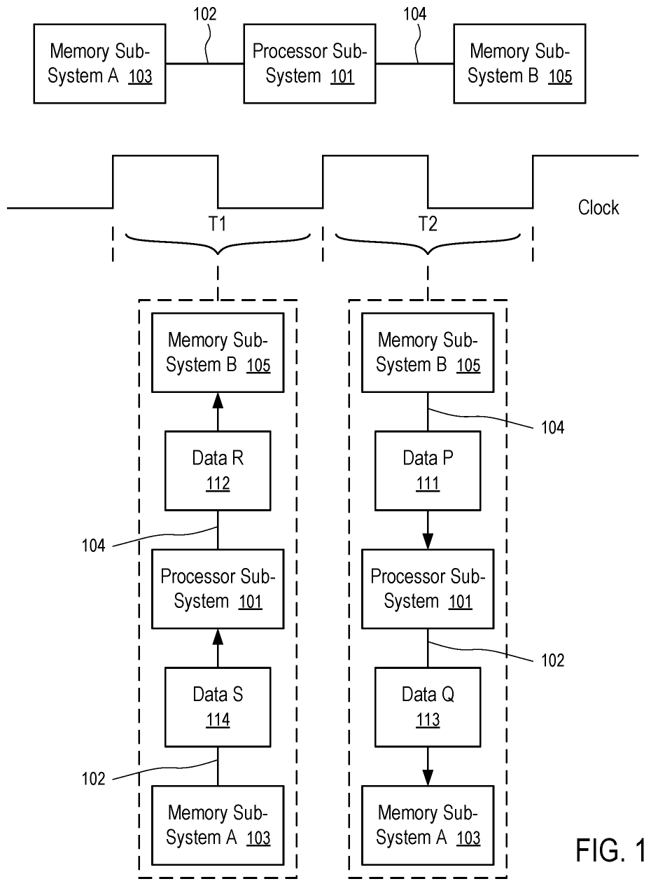

FIG. 1 shows a system configured with systolic memory access according to one embodiment.

In FIG. 1, two separate connections 102 and 104 are provided from a processor sub-system 101 to two separate memory sub-systems 103 and 105 respectively. In some predetermined or selected clock cycles (e.g., odd cycles, such as clock cycle T1), the communications over the connections 102 and 104 are configured in one direction; and in other clock cycles (e.g., even cycles, such as clock cycle T2), the communications are configured in the opposite direction. Preferably, the connections 102 and 104 are optical (e.g., via ribbons of optical fibers that are configured separate from a printed circuit board).

For example, at clock cycle T1, the connection 102 is configured to communicate data 114, retrieved from the memory sub-system 103, in the direction of from the memory sub-system 103 to the processor sub-system 101; and the connection 104 is configured to communicate data 112, to be written into the memory sub-system 105, in the direction of from the processor sub-system 101 to the memory sub-system 105. In contrast, at clock cycle T2, the connection 104 is configured to communicate data 111, retrieved from the memory sub-system 105, in the direction of from the memory sub-system 105 to the processor sub-system 101; and the connection 102 is configured to communicate data 113, to be written into the memory sub-system 103, in the direction of from the processor sub-system 101 to the memory sub-system 103.

Since the communications over a connection (e.g., 102 or 104) are in a predetermined direction at each clock cycle (e.g., T1 or T2), the lack of bi-direction communication capability over an optical link is no longer a limiting factor in the use of a computing system that uses the technique of systolic memory access.

Optionally, the processor sub-system can have a pipeline of processing elements configured to propagate two pipelines of tasks in opposite directions, in sync with the communication directions of the connections 102 and 104.

For example, input data 111 can be retrieved from the memory sub-system 105 and processed via a pipeline in the processor sub-system 101 for a number of clock cycles to generate output data that is written into the memory sub-system 103. Similarly, input data 114 can be retrieved from the memory sub-system 103 and processed via a pipeline in the processor sub-system 101 for a number of clock cycles to generate output data that is written into the memory sub-system 105.

Optionally, the propagation of data within the processor sub-system 101 can change directions. For example, the output data generated from processing the input data 111 retrieved from the memory sub-system 105 can be written back to the memory sub-system 105 after a number of clock cycles of pipeline processing within the processor sub-system 101; and the output data generated from processing the input data 114 retrieved from the memory sub-system 103 can be written back to the memory sub-system 103 after a number of clock cycles of pipeline processing within the processor sub-system 101.

Optionally, the input data retrieved from the memory sub-systems 103 and 105 can be combined via the pipeline processing in the processor sub-system 101 to generate output data to be written into one or more of the memory sub-systems 103 and 105.

For example, the input data 111 and 114 can be combined in the processor sub-system 101 to generate output data that is written into the memory sub-system 105 (or memory sub-system 103) after a number of clock cycles.

FIG. 1 illustrates an example where when one connection (e.g., 102) is propagating input data toward the processor sub-system 101, the other connection (e.g., 104) is propagating output data away from the processor sub-system 101. Alternatively, when one connection (e.g., 102) is propagating input data toward the processor sub-system 101, the other connection (e.g., 104) is propagating input data into the processor sub-system 101; and thus, the memory sub-systems 103 and 105 can be read or written in unison in some clock cycles.

In general, the directions of communications over the connections 102 and 104 can be predetermined by a data movement manager. The data movement manager can allocate the directions of communications for the connections 102 to best utilize the communication bandwidth of the connections 102 and 104 for improved overall performance of the system.

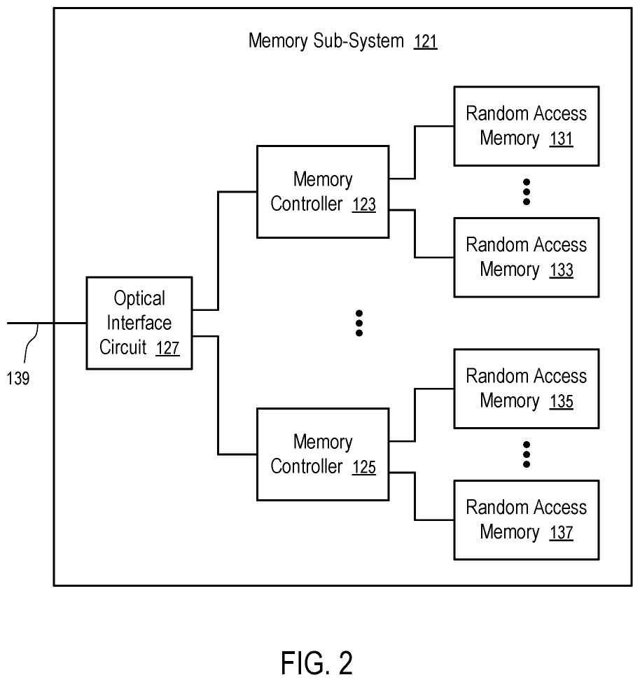

FIG. 2 shows a memory sub-system configured to facilitate systolic memory access according to one embodiment. For example, the memory sub-systems 103 and 105 in FIG. 1 can be implemented in a way as in FIG. 2.

In FIG. 2, the memory sub-system 121 includes an optical interface circuit 127 to transmit or receive data via a ribbon 139 of one or more optical fibers. For example, the connections 102 and 104 in FIG. 1 can be implemented using the ribbons (e.g., 139) of optical fibers when the memory sub-systems 103 and 105 and the processor sub-system 101 are configured with optical interface circuits (e.g., 127).

The optical interface circuit 127 can have one or more buffers for a plurality of memory controllers 123, . . . , 125. The memory controllers 123, . . . , 125 can operate in parallel to move data between the optical interface circuit 127 and the random access memory 131, 133; . . . ; 135, . . . , 137 controlled by the respective memory controllers 123, . . . , 125.

Optionally, a same read (or write) command can be applied to the plurality of memory controllers 123, . . . , 125. The read (or write) command specifies a memory address. Each of the memory controllers 123, . . . , 125 can execute the same command to read data from (or write data into) the same memory address in a respective memory (e.g., 131, . . . , 135) for high bandwidth memory access through the optical interface circuit 127.

Optionally, each of the random access memories (e.g., 131, . . . , 133) can have a same addressable memory address; and the memory controller 123 can operate the random access memories (e.g., 131, . . . , 133) in parallel to read or write data at the memory address across the memories (e.g., 131, . . . , 133) for improved memory access bandwidth.

Alternatively, the memory controllers 123, . . . , 125 can be controlled via different read commands (or write commands) (e.g., directed at different memory addresses).

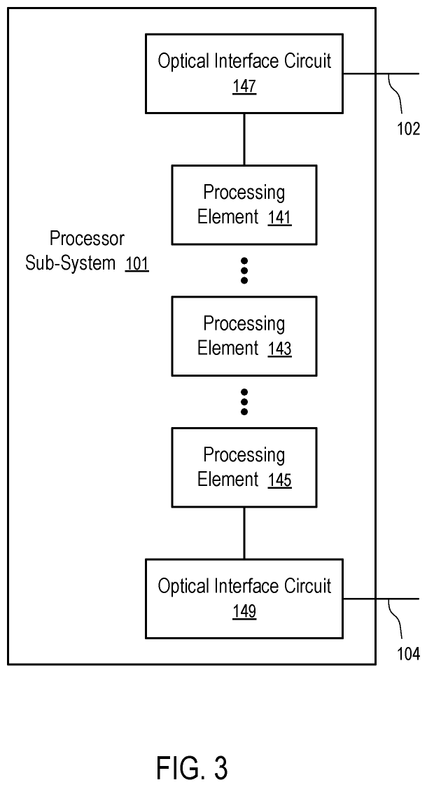

FIG. 3 shows a processor sub-system configured to facilitate systolic memory access according to one embodiment. For example, the processor sub-system 101 in FIG. 1 can be implemented in a way as in FIG. 3.

In FIG. 3, the processor sub-system 101 includes optical interface circuits 147 and 149 to transmit or receive data via connections 102 and 104 that can be implemented via ribbons 139 of one or more optical fibers.

The optical interface circuit 127 can have one or more buffers for a plurality of processing elements 141, . . . , 143, . . . , and 145.

The processing elements 141, . . . , 143, . . . , and 145 can be configured to form a pipeline to process input data (e.g., 114 as in FIG. 1) received over the connection 102 to generate output data (e.g., 112 in FIG. 1) on the connection 104.

Similarly, the processing elements 141, . . . , 143, . . . , and 145 can be configured to form another pipeline to process input data (e.g., 111 as in FIG. 1) received over the connection 104 to generate output data (e.g., 113 in FIG. 1) on the connection 102.

In some implementations, the processing pipelines implemented via the processing elements 141, . . . , 143, . . . , and 145 are hardwired; and the propagation of data among the processing elements 141, . . . , 143, . . . , and 145 are predetermined for the clock cycles (e.g., T1 and T2) in a way similar to the directions of communications of the connections 102 and 104.

In other implementations, the processing pipelines implemented via the processing elements 141, . . . , 143, . . . , and 145 can be programmed via a host system; and the propagation of data among the processing elements 141, . . . , 143, . . . , and 145 can be dynamically adjusted from clock cycles to clock cycles (e.g., T1 and T2) to balance the workloads of the processing elements 141, . . . , 143, . . . , and 145 and the bandwidth usages of the connections 102 and 104.

Optionally, the processing elements 141, . . . , 143, . . . , and 145 can be programmed via a host system to perform parallel operations.

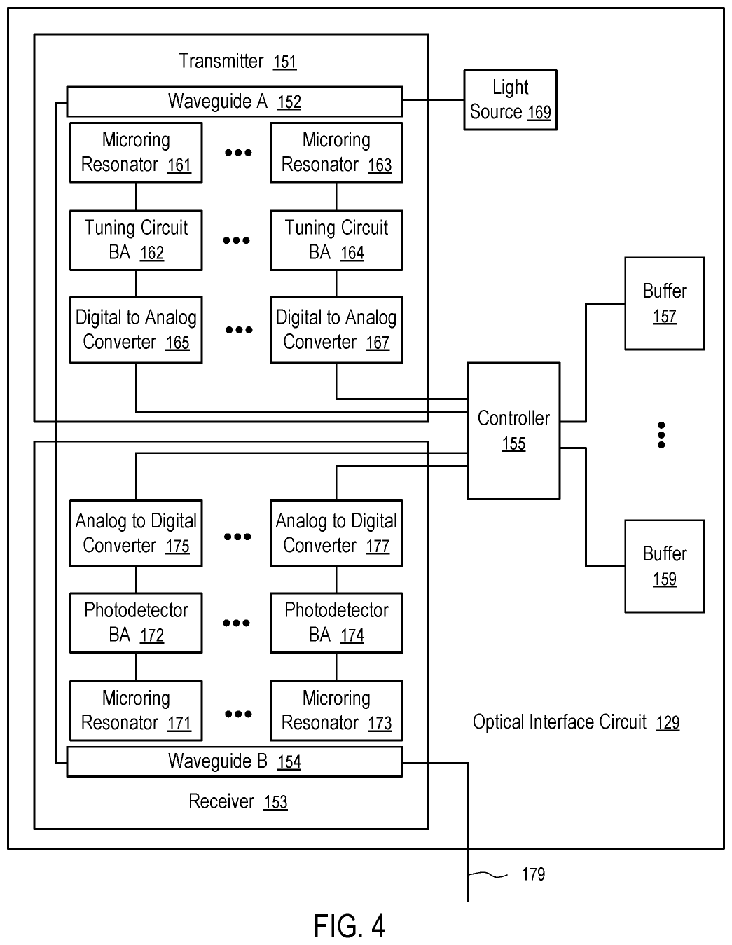

FIG. 4 shows an optical interface circuit operable in a system of systolic memory access according to one embodiment.

For example, the optical interface circuits 127, 147, and 149 in FIG. 2 and FIG. 3 can be implemented as in FIG. 4.

In FIG. 4, the optical interface circuit 129 includes a transmitter 151, a receiver 153, a controller 155, and one or more buffers 157, . . . , 159.

An optical fiber ribbon 179 can be connected to a waveguide 154 configured in the receiver 153, and a waveguide 152 configured in the transmitter 151. The waveguides 152 and 154 are connected to each other in the optical interface circuit 129 to provide an optical signal path between a light source 169 and the optical fiber ribbon 179.

The transmitter 151 and the receiver 153 are configured to transmit or receive data in response to the optical interface circuit 129 being in a transmission mode or a reception mode.

When the optical interface circuit 129 is in a transmission mode, the transmitter 151 is in operation to transmit data. Unmodulated optical signals from the light source 169 can propagate to the waveguide 152 in the transmitter 151 for modulation and transmission through the waveguide 154 in the receiver and the optical fiber ribbon 179. Optionally, the receiver 153 can operate when the optical interface circuit 129 is in the transmission mode to detect the optical signals modulated by the transmitter 151 for the controller 155 to verify the correct transmission of data by the transmitter 151.

When the optical interface circuit 129 is in a reception mode, the receiver 153 is in operation to receive data. Modulated optical signals propagating from the optical fiber ribbon 179 into the waveguide 154 of the receiver 153 can be detected in the receiver 153. Signals passing through the waveguides 154 and 152 can be absorbed for termination. For example, during the reception mode of the optical interface circuit 129, the light source 169 can be configured to stop outputting unmodulated optical signals and to absorb the optical signals coming from the waveguide 152. Optionally, the transmitter 151 can be configured to perform operations to attenuate the signals going through the waveguide 152 when the optical interface circuit 129 is in the reception mode.

The light source 169 can be configured as part of the optical interface circuit 129, as illustrated in FIG. 4. Alternatively, the optical interface circuit 129 can include an optical connector for connecting an external light source 169 to the waveguide 152 (e.g., in a way similar to the connection of the optical fiber ribbon 179 to the waveguide 154).

The transmitter 151 can have a plurality of microring resonators 161, . . . , 163 coupled with the waveguide 152 to modulate the optical signals passing through the waveguide 152. A microring resonator (e.g., 161 or 163) can be controlled via a respective tuning circuit (e.g., 162 or 164) to change the magnitude of the light going through the waveguide 152. A tuning circuit (e.g., 162 or 164) of a microring resonator (e.g., 161 or 163) can change resonance characteristics of the microring resonator (e.g., 161 or 163) through heat or carrier injection. Changing resonance characteristics of the microring resonator (e.g., 161 or 163) can modulate the optical signals passing through waveguide 152 in a resonance frequency/wavelength region of the microring resonator (e.g., 161 or 163). Different microring resonators 161, . . . , 163 can be configured to operate in different frequency/wavelength regions. The technique of wavelength division multiplexing (WDM) allows high bandwidth transmissions over the connection from waveguide 152 through the ribbon 179.

During the transmission mode, the controller 155 (e.g., implemented via a logic circuit) can apply data from the buffers 157, . . . , 159 to the digital to analog converters 165, . . . , 167. Analog signals generated by the digital to analog converters 165, . . . , 167 control the turning circuits 162 in changing the resonance characteristics of the microring resonators 161, . . . , 163 and thus the modulation of optical signals passing through the waveguide 152 for the transmission of the data from the buffers 157, . . . , 159.

The receiver 153 can have a plurality of microring resonators 171, . . . , 173 coupled with the waveguide 154 to detect the optical signals passing through the waveguide 154. Different microring resonators 171, . . . , 173 can be configured to operate in different frequency/wavelength regions to generate output optical signals through resonance. Photodetectors 172, . . . , 174 can measure the output signal strengths of the microring resonators 171, . . . , 173, which correspond to the magnitude-modulated optical signals received from the optical fiber ribbon 179. Analog to digital converters 175, . . . , 177 convert the analog outputs of the photodetectors 172, . . . , 174 to digital outputs; and the controller 155 can store the digital outputs of the analog to digital converters 175, . . . , 177 to the buffers 157, . . . , 159.

In some implementations, when the optical interface circuit 129 is configured for the memory sub-system 121 of FIG. 2, the optical interface circuit 129 can optionally be configured to have a plurality of buffers 157, . . . , 159 accessible, in parallel, respectively by the plurality of memory controllers 123, . . . , 125 in the memory sub-system 121 for concurrent operations (e.g., reading data from or writing data to the buffers 157, . . . , 159).

In some implementations, when the optical interface circuit 129 is configured for the processor sub-system 101 of FIG. 3, the optical interface circuit 129 can optionally be configured to have a plurality of buffers 157, . . . , 159 accessible, in parallel, respectively by a plurality of processing elements 141, . . . , 143, . . . , 145 for concurrent operations (e.g., reading data from or writing data to the buffers 157, . . . , 159).

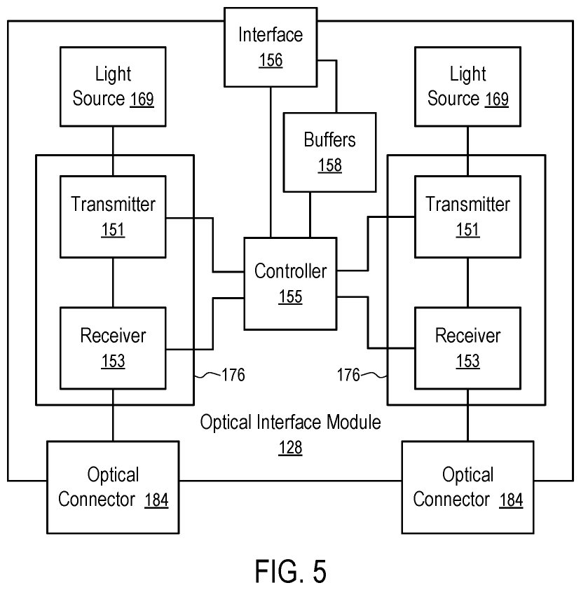

FIG. 5 shows an optical interface module 128 according to one embodiment. For example, the optical interface circuits 127, 147 and 149 in FIG. 2 and FIG. 3 can be implemented via the optical interface module 128 of FIG. 5.

In FIG. 5, the optical interface module 128 includes two sets of electro-optical circuits, each containing a light source 169, an optical transceiver 176 having a transmitter 151 and a receiver 153, and an optical connectors 184. For example, the transmitters 151 and receivers 153 of the optical interface module 128 can be implemented in a way as illustrated in FIG. 4.

Each set of the electro-optical circuits has a waveguide (e.g., including 152, 154 as in FIG. 4) that is connected from the optical connector 184 through the receiver 153 and the transmitter 151 to the light source 169, as in FIG. 4.

A controller 155 of the optical interface module 128 can control the operating mode of each set of the electro-optical circuits to either transmit data from the buffers 158 or receive data into the buffers 158, as in FIG. 4.

An electric interface 156 can be configured to operate the optical interface module 128 as a memory sub-system servicing a host system (or as a host system using the services of one or more memory sub-systems).

For example, the optical interface module 128 can be used to implement the optical interface circuits 147 and 149 of the processor sub-system 101 of FIG. 3 by using the optical connectors 184 for the connections 102 and 104 respectively. The processing elements 141, 145, and optionally other processing elements (e.g., 143) can be each implemented via a system on a chip (SoC) device having a memory controller to read from, or write data to, the interface 156.

For example, the interface 156 can include a plurality of host interfaces for the processing elements 141 and 145 (or 141, . . . , 143, . . . , 145) respectively. The host interfaces can receive read/write commands (or load/store instructions) in parallel as if each of the host interfaces were configured for a separate memory sub-system.

The controller 155 is configured to transmit the commands/instructions and their data received in the host interfaces for transmission at least in part over the optical connectors 184.

Optionally, the optical interface module 128 further includes two electric interfaces for transmission control signals (and addresses) to the memory sub-systems (e.g., 103 and 105) that are connected to the optical connectors 184 respectively.

To enable systolic memory access, the optical interface module 128 can be configured to place the two sets of electro-optical circuits in opposite modes. For example, when one optical connector 184 is used by its connected receiver 153 for receiving data, the other set of electro-optical circuit can be automatically configured by the controller 155 in a transmission mode; and when one optical connector 184 is used by its connected transmitter 151 for transmitting data, the other set of electro-optical circuit can be automatically configured by the controller 155 in a reception mode.

In another example, the optical interface module 128 can be used to implement the optical interface circuit 127 of the memory sub-system 121 of FIG. 2 by attaching one of the optical connectors 184 to the ribbon 139 of one or more optical fibers. Optionally, the other optical connector 184 of the optical interface module 128 can be connected to another ribbon that is in turn connected to another processor sub-system (e.g., similar to the connection to the processor sub-system 101 in FIG. 1). Thus, the memory sub-system 121 can be chained between two processor sub-systems (e.g., 101); and the chain of memory sub-systems to processor sub-systems can be extended to include multiple processor sub-systems and multiple memory sub-systems, where each processor sub-system is sandwiched between two memory sub-systems. Optionally, the chain can be configured a closed loop, where each memory sub-system is also sandwiched between two processor sub-system 101.

Optionally, when used in a memory sub-system 121, the interface 156 can include a plurality of memory interfaces. Each of the memory interfaces can operate as a host system to control a memory controller (e.g., 123 or 125) by sending read/write commands (or store/load instructions) to the memory controller (e.g., 123 or 125). Thus, each of the memory controllers (e.g., 123) and its random memory (e.g., 131, . . . , 133) in the memory sub-system 121 can be replaced with, or be implemented using, a conventional memory sub-system, such a solid state drive, a memory module, etc.

Alternatively, when used in a memory sub-system 121, the interface 156 can be simplified as connections for the memory controllers 123, . . . , 125 to directly access respective buffers 158 (e.g., 157, . . . , 159) in the optical interface module 128.

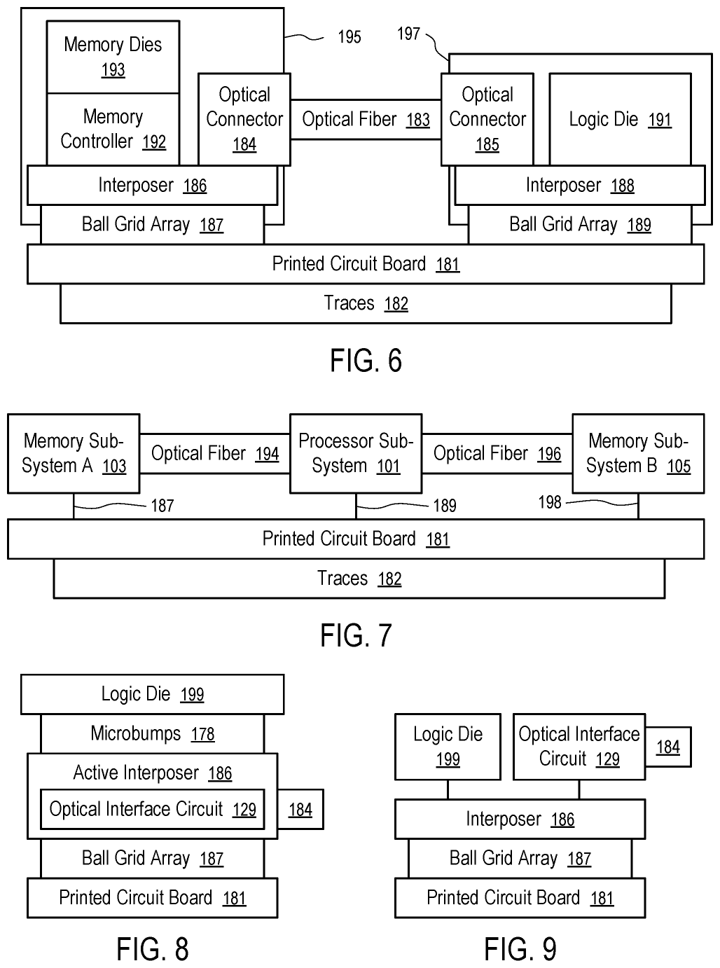

FIG. 6 shows a configuration to connect a memory sub-system and a processor sub-system according to one embodiment. For example, the connection 102 between the memory sub-system 103 and the processor sub-system 101 in FIG. 1 can be implemented using the configuration of FIG. 6. For example, the connection 104 between the memory sub-system 105 and the processor sub-system 101 in FIG. 1 can be implemented using the configuration of FIG. 6.

In FIG. 6, a memory sub-system (e.g., 103 or 105) can be enclosed in an integrated circuit package 195; and a processor sub-system 101 can be enclosed in another integrated circuit package 197.

Within the integrated circuit package 195, the memory sub-system (e.g., 103, 105, or 121) includes an interposer 186 configured to provide an optical connector 184 to an optical fiber 183 (e.g., ribbon 139 or 179). Data to be transmitted to, or received in, the buffers (e.g., 157, . . . , 159) of an optical interface circuit 129 of the memory sub-system is configured to be communicated through the optical fiber 183 over the optical connector 184. Control signals and power are configured to be connected to the memory sub-system via traces 182 configured on the printed circuit board 181. The optical fiber 183 can be configured in a ribbon that is separate from the printed circuit board 181.

Similarly, within the integrated circuit package 197, the processor sub-system (e.g., 101) includes an interposer 188 configured to provide an optical connector 185 to the optical fiber 183 (e.g., ribbon 179). Data to be transmitted to, or received in, the buffers (e.g., 157, . . . , 159) of an optical interface circuit 129 of the processor sub-system is configured to be communicated through the optical fiber 183 over the optical connector 185. Control signals and power are configured to be connected to the processor sub-system via traces 182 configured on the printed circuit board 181. The optical fiber 183 can be configured in a ribbon that is separate from the printed circuit board 181.

In FIG. 6, both the package 195 of the memory sub-system and the package 197 of the processor sub-system are mounted on a same printed circuit board 181 that has traces 182 configured to route signals for control (e.g., clock) and power.

The communications over the optical fiber 183 can be at a clock frequency that is multiple times of the frequency of the clock signals (e.g., times T1 and T2 in FIG. 1) transmitted over the traces 182 and used to control the communication directions in the optical fiber 183.

Each of the memory sub-system enclosed within the package 195 and the processor sub-system enclosed within the package 197 can include an optical interface circuit (e.g., 129) to bridge the optical signals in the optical fiber 183 and electrical signals in the memory/processor sub-system.

Control signals and power can be connected via traces 182 through a ball grid array 187 (or another integrated circuit chip mounting technique) and the interposer 186 to the controller 155 of the optical interface circuit 129 of the memory sub-system and the memory controllers (e.g., 192) in the memory sub-system. The memory sub-system can have one or more memory dies 193 stacked on a logic die in which the memory controllers (e.g., 192) are formed.

Similarly, control signals and power can be connected via traces 182 through a ball grid array 189 (or another integrated circuit chip mounting technique) and the interposer 188 to the controller 155 of the optical interface circuit 129 of the processor sub-system and the logic die 191 of the processor sub-system.

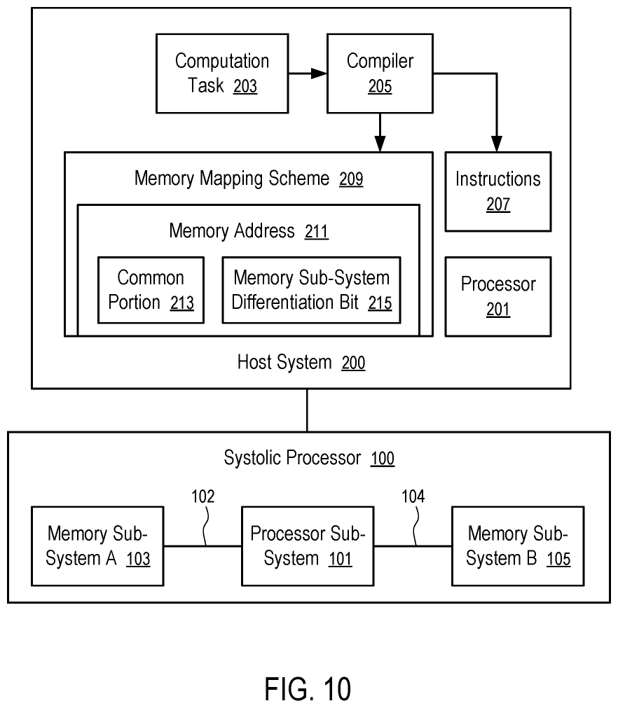

FIG. 7 shows a configuration to connect memory sub-systems and a processor sub-system for systolic memory access according to one embodiment. For example, the memory sub-systems 103 and 105 and the processor sub-system 101 in FIG. 1 can be connected in a configuration of FIG. 7.

In FIG. 7, the memory sub-systems 103 and 105 and the processor sub-system 101 are mounted on a same printed circuit board 181 for control and power. For examples, the memory sub-systems 103 and 105 and the processor sub-system 101 can be each enclosed within a single integrated circuit package and connected to the traces 182 on the printed circuit board 181 via a respective ball grid arrays (e.g., 187, 198, or 198), as in FIG. 6. Alternative techniques for mounting integrated circuit chip on printed circuit boards can also be used.

The traces 182 on the printed circuit board 181 can be used to connect signals (e.g., clock) and power that do not require a high communication bandwidth to the memory sub-systems 103 and 105 and the processor sub-system 101. Ribbons of optical fibers 194 and 196 can be used to connect data, address, and/or command communications between the processor sub-system 101 and the memory sub-systems 103 and 105.

For example, the memory sub-system 103 and the processor sub-system 101 can be connected in a way as illustrated in FIG. 6; and the memory sub-system 105 and the processor sub-system 101 can be connected in a way as illustrated in FIG. 6. The interposer 188 in the processor sub-system 101 can have two optical connectors (e.g., 185): one connected to the optical fiber 194, and the other to the optical fiber 196.

In some implementations, the communication directions in the optical fibers (e.g., 194 and 196) are predetermined for clock cycles.

For example, in odd numbered clock cycles, the optical interface circuit 129 in the memory sub-system 103 is in a transmission mode; and the optical interface circuit 129 in the processor sub-system 101 and connected to the optical fiber 194 is in a reception mode. Thus, the data transmission in the optical fiber 194 is from the memory sub-system 103 toward the processor sub-system 101. Similarly, in even numbered clock cycles, the optical interface circuit 129 in the memory sub-system 103 is in a reception mode; and the optical interface circuit 129 in the memory sub-system 103 and connected to the optical fiber 194 is in a transmission mode. Thus, the data transmission in the optical fiber 194 is from the processor sub-system 101 toward the memory sub-system 103 toward.

Alternatively, a processor sub-system 101 (or a host system) can use a control signal transmitted over the traces 182 to control the direction of transmission over the optical fiber 194. For example, when a first signal (separate from a clock signal) is sent over the traces 182 to the memory sub-system 103 (e.g., from the processor sub-system 101 or the host system), the optical interface circuit 129 in the memory sub-system 103 is in a transmission mode; and the processor sub-system 101 can receive data from the memory sub-system 103 over the optical fiber 194. When a second signal (separate from a clock signal and different from the first signal) is sent over the traces 182 to the memory sub-system 103 (e.g., from the processor sub-system 101 or the host system), the optical interface circuit 129 in the memory sub-system 103 is in a reception mode; and the processor sub-system 101 can transmit data to the memory sub-system 103 over the optical fiber 194. Thus, the data transmission direction over the optical fiber 194 (or 196) can be dynamically adjusted based on the communication needs of the system.

Data transmitted from the processor sub-system 101 to a memory sub-system 103 (or 105) over an optical fiber 194 (or 196) can include outputs generated by the processor sub-system 101. Optionally, data retrieved from one memory sub-system (e.g., 105) can be moved via the processor sub-system 101 to another memory sub-system (e.g., 103) via an optical fiber (e.g., 194).

Further, data transmitted from the processor sub-system 101 to a memory sub-system 103 (or 105) over an optical fiber 194 can include commands (e.g., read commands, write commands) to be executed in the memory sub-system 103 (or 105) and parameters of the commands (e.g., addresses for read or write operations). Alternatively, the commands can be transmitted via the traces 182, especially when the sizes of the commands (and their parameters) are small, compared to the data to be written into the memory sub-system 103 (or 105). For example, when the memory controllers 123, . . . , 125 can share a same command and an address for their operations in accessing their random access memories (e.g., 131, . . . , 133; or 135, . . . , 137), the size of the command and the address can be smaller when compared to the size of the data to be written or read via the command.

Data transmitted to the processor sub-system 101 from a memory sub-system 103 (or 105) over an optical fiber 194 can include data retrieved from the random access memories 131, . . . , 133, . . . , 135, . . . , 137 in response to read commands from the processor sub-system 101.

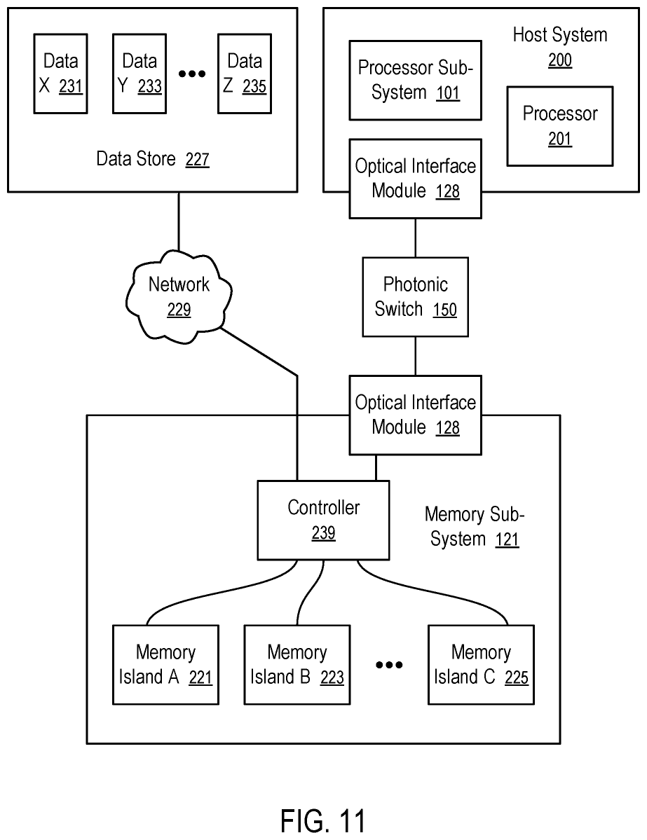

The interposers (e.g., 186) of the memory sub-systems 103 and the processor sub-system 101 can be implemented using the technique of FIG. 8 or FIG. 9.

FIG. 8 and FIG. 9 show techniques to connect a logic die to a printed circuit board and an optical fiber according to one embodiment.

In FIG. 8, an active interposer 186 is configured on an integrated circuit die to include active circuit elements of an optical interface circuit 129, such as the transmitter 151 and receiver 153, in addition to the wiring to directly connect the ball grid array 187 to microbumps 178. The active interposer 186 includes the optical connector 184 for a connection to an optical fiber ribbon 179. Optionally, the active interposer 186 further includes the controller 155 and/or the buffers 157, . . . , 159 of the optical interface circuit 129. Alternatively, the controller 155 can be formed on a logic die 199. For example, when the active interposer 186 is used in a processor sub-system 101, the logic die 199 can contain the logic circuits (e.g., processing elements 141, . . . , 143, . . . , or 145) of the processor sub-system 101. For example, when the active interposer 186 is used in a memory sub-system 121, the logic die 199 can contain the logic circuits (e.g., memory controllers 123, . . . , 125) of the memory sub-system 121.

The active interposer 186 is further configured to provide wires for the control and power lines to be connected via the ball grid array 187 through microbumps 178 to the circuitry in the logic die 199.

For example, the active optical interposer 186 can include waveguides 152 and 154, microring resonators 171, . . . , 173 and 161, . . . , 163, digital to analog converters 165, . . . , 167, tuning circuits 162, . . . , 164, analog to digital converters 175, . . . , 177, photodetectors 172, . . . , 174, wire connections via a ball grid array 187 toward traces 182 on a printed circuit board 181, wire connections via microbumps 178 to one or more logic dies 199 (and memory dies 193), wires routed between the wire connections, and a port or connector 184 to an optical fiber (e.g., 183, 194, or 196).

In contrast, FIG. 9 shows a passive interposer 186 configured between a printed circuit board 181 and integrated circuit dies, such as a logic die 199 and a die hosting an optical interface circuit 129 and a port or connection 184 to an optical fiber (e.g., 183, 194, or 196). The passive interposer 186 contains no active elements and is configured to provide wire connections between the circuitry in the logic die 199 and the circuitry in the optical interface circuit 129, and wire connections to the traces 182 on the printed circuit board 181.

In some implementations, an optical interface module 128 is configured as a computer component manufactured on an integrated circuit die. The optical interface module 128 includes the optical interface circuit 129 formed on a single integrated circuit die, including at least one optical connector 184 and optionally, a light source 169 for the transmitter 151. Optionally, the optical interface module 128 includes the wires and connections of the active interposer 186 that are not directly connected to the optical interface circuit 129. Alternatively, the optical interface module 128 is configured to be connected to other components of a memory sub-system (e.g., 121) (or a processor sub-system (e.g., 101)) via a passive interposer 186, as in FIG. 9.

In one embodiment, an optical interface module 128 is configured to provide access, via an optical fiber 183, multiple sets of memories (e.g., 131, . . . , 133; . . . , 135, . . . , 137), each having a separate memory controller (e.g., 123, or 125). The multiple sets of memories (e.g., 131, . . . , 133; . . . , 135, . . . , 137) and their memory controllers (e.g., 123, . . . , 125) can be configured to be enclosed within multiple integrated circuit packages to form multiple memory chips. Each of the integrated circuit packages is configured to enclose a set of memories (e.g., 131, . . . , 133) formed on one or more memory dies 193 and to enclose a memory controller 192 formed on a logic die (e.g., 199) (or a portion of the memory dies 193). Optionally, the optical interface module 128 can be configured as a host of the memory chips, each enclosed within an integrated circuit package. The optical interface module 128 can write data received from the optical fiber 183 into the memory chips during one clock cycle, and transmit data retrieved from the memory chips into the optical fiber 183 during another clock cycle. Each of the memory chips can operate independent from other memory chips. Optionally, each of the memory chips can be replaced with a memory sub-system. The optical interface module 128 can be configured to optionally access the memory chips or memory sub-systems in parallel for improved memory throughput. For example, a memory sub-system 103 or 105 in FIG. 1 and FIG. 7 can be implemented with the combination of the memory chips (or memory sub-systems) controlled by an optical interface module 128 functioning as a host system of the memory chips (or memory sub-systems) for an increased memory capacity and an increased access bandwidth.

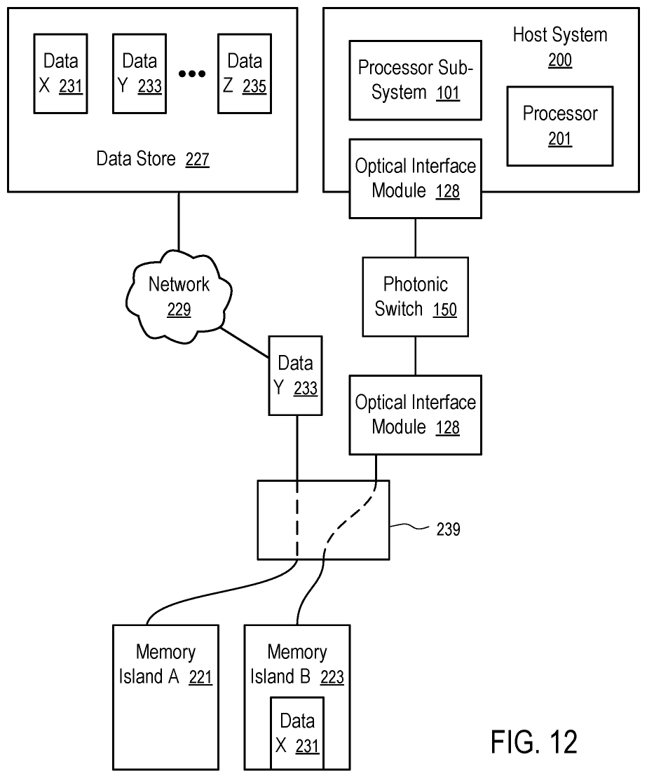

To best utilize the high memory access bandwidth offered by the memory sub-systems 103 and 105 over optical fibers 194 and 196, a memory manager can be configured to generate a memory mapping scheme with corresponding instructions for the processor sub-system 101, as in FIG. 10.

FIG. 10 shows a technique to use a compiler to configure the operations of systolic memory access according to one embodiment.

For example, the technique of FIG. 10 can be used to control the operations of a processor sub-system 101 to access memory sub-systems 103 and 105 of FIG. 1 and FIG. 7.

In FIG. 10, a systolic processor 100 includes a processor sub-system 101 connected to separate memory sub-systems 103 and 105, as in FIG. 1 and FIG. 7. A host system 200 can control the memory access pattern in the systolic processor 100.

For example, a compiler 205 can be configured as a memory manager running in the host system 200 to schedule the data and workload flow in the hardware of the systolic processor 100 to best utilize the hardware capability. The compiler 205 can be configured to generate a static memory mapping scheme 209 for a given computation task 203. The compiler 205 can be configured to try different approaches of using the memory provided by the memory sub-systems 103 and 105, and schedule the read/write commands to meet various timing requirements, such as the latency requirements of the memory sub-systems 103 and 105 in performing the read/write operations, and data usage and processing timing requirements of processors/processing elements 141, . . . , 143, . . . , 145 in the processor sub-system 101, etc. The compiler 205 can select a best performing solution to control the activities of the processor sub-system 101.

The computation task 203 can be programmed in a way where memory resources are considered to be in a same virtual memory system. The compiler 205 is configured to map the memory resources in the same virtual memory system into the two memory sub-systems 103 and 105 via a memory mapping scheme 209. A memory address in the virtual memory system can be used as the common portion 213 of a memory address 211 used to address the memory sub-systems 103 or 105. A memory sub-system differentiation bit 215 is included in the memory address 211 to indicate whether the memory address 211 is in the memory sub-system 103 or in the memory sub-system 105.

For example, when the memory sub-system differentiation bit 215 has the value of zero (0), the memory address 211 is in the memory sub-system 103. The processor sub-system 101 can provide the common portion 213 of the memory address 211 to read or write in the memory sub-system 103 at a corresponding location represented by the common portion 213 of the memory address 211.

When the memory sub-system differentiation bit 215 has the value of one (1), the memory address 211 is in the memory sub-system 105. The processor sub-system 101 can provide the common portion 213 of the memory address 211 to read or write in the memory sub-system 105 at a corresponding location represented by the common portion 213 of the memory address 211.

The common portion 213 of the memory address 211 can be programmed in, or mapped from a virtual memory address specified in, the computation task 203. The compiler 205 can determine the memory sub-system differentiation bit 215 to map the address 211 to either the memory sub-system 103 or the memory sub-system 105. The processor sub-system 101 can execute the instructions 207 of the computation task 203 to access the memory sub-system 103 or the memory sub-system 105 according to the differentiation bit 215.

Optionally, the differentiation bit 215 of some memory addresses (e.g., 211) can be computed by the processor sub-system 101 in execution of the instructions 207 configured by the compiler 205 to best utilize the memory access bandwidth offered by the connections 102 and 104.

In one implementations, a memory location in the memory sub-system 103 can have a same physical address, represented by the common portion 213, as a corresponding memory location in the memory sub-system 105. To differentiate between the two memory locations in the memory sub-systems 103 and 105 respectively, the systolic processor 100 can be configured to use an additional differentiation bit 215 based on the commands generated by compute nodes, such as system on a chip (SoC) devices in the processor sub-system 101. The compute nodes (e.g., SoC devices) can generate memory addresses (e.g., 211) with this separate/additional differentiation bit (e.g., 215) to indicate whether a memory operation is to be in the memory sub-system 103 or 105. A controller (e.g., 155) in the processor sub-system 101 consumes the differentiation bit 215 to direct the corresponding operation to either the memory sub-system 103 or 105 with the remaining bits of memory addresses (e.g., common portion 213) being provided by the processor sub-system 101 to address a memory location in the memory sub-system 103 or 105.

The compiler 205 can be configured with an internal mapping of the hardware of the systolic processor 100 and a transaction level model (TLM) of the hardware. The compiler 205 can determine, for the given computation task 203, the read and write latency tolerances and decide how to map and extract data using systolic data movements. When a memory sub-system 103 or 105 is implemented via multiple, separate memory chips (or sub-systems), memory virtualizer can be used to view the memory capacity of a collection of memory chips (or sub-systems) as a contiguous memory block to assist in generating the physical addresses used in the static memory mapping scheme 209.

Optionally, the compiler 205 can be configured to instruct the systolic processor 100 to read from one memory sub-system (e.g., 103) and then write to another (e.g., 105).

For example, in an application configured to the process of the training of an artificial neural network model, the neuron weights can be initially stored in a memory sub-system (e.g., 103); and the updated neuron weights computed by the processor sub-system 101 can be written to the corresponding locations in the other memory sub-system (e.g., 105). Subsequently, the roles of the memory sub-systems 103 and 105 can be reversed for the flowing of weight data in the opposite direction.

The differentiation bit 215 configured for controlling the selection of a memory sub-system (e.g., 103 or 105) can be used by a controller 155 of the optical interface circuits 129 of the processor sub-system 101 to select the memory sub-system (e.g., 103 or 105) currently being addressed. For example, registers (or using scratch pad memory) in the controller 155 of the optical interface module 128 of the processor sub-system 101 can be configured to identify the currently selected memory sub-system (e.g., 103 or 105) for write or read by the processor sub-system 101. For example, a bit value of zero (0) can be used to indicate that the memory sub-system 103 is to be read from, while the memory sub-system 105 is to be written into; alternatively, a bit value of one (1) can be used to indicate writing to the memory sub-system 105 while reading from memory sub-system 103. Such a register can be masked on to an outbound read/write request enabling the routing/selection of the correct memory destination. The system does not require changes to the memory controllers in the system on a chip (SoC) devices of the processor sub-system 101, but relies on the controller 155 of the optical interface circuits 129 of the processor sub-system 101.

In some implementations, the processor 201 can be configured to send signals through the traces 182 in the printed circuit board 181 (e.g., as in FIG. 7) of the systolic processor 100 to control the communication directions in the connections 102 and 104.

In one embodiment, a method is provided to facilitate systolic memory access according to one embodiment.

For example, the method of systolic memory access can be implemented in a computing system of FIG. 10, where the systolic processor 100 can be configured on a printed circuit board 181 in a configuration illustrated in FIG. 7.

For example, the method of systolic memory access includes: connecting a processor sub-system 101 between a first memory sub-system 103 and a second memory sub-system 105; receiving a first clock signal (e.g., identifying a time period T1); and configuring, in response to the first clock signal, a communication direction of a first connection 102 between the processor sub-system 101 and the first memory sub-system 103 to receive first data 114 in the processor sub-system 101 from the first memory sub-system 103.

For example, the first data 114 can include data retrieved from the first memory sub-system 103 after execution of read commands (e.g., transmitted to the first memory sub-system 103 in a time period identified by a previous clock signal).

Further, the method of systolic memory access includes configuring, in response to the first clock signal, a communication direction of a second connection 104 between the processor sub-system 101 and the second memory sub-system 105 to transmit second data 112 from the processor sub-system 101 to the second memory sub-system 105.

For example, the second data 112 can include data to be written via execution of write commands in the second memory sub-system 105.

Optionally, the second data 112 can include data representative of read commands to retrieve data from the second memory sub-system 105. For example, after the execution of the read commands, the retrieved data can be communicated from the second memory sub-system 105 to the processor sub-system 101 after the communication direction in the connection 104 is reversed in response to a subsequent clock signal.

Optionally, the second data 112 can include data representative of addresses for execution of read commands and/or write commands in the second memory sub-system.

Further, the method of systolic memory access includes receiving a second clock signal (e.g., identifying a time period T2), and reversing, in response to the second clock signal, the communication direction of the first connection 102 and the communication direction of the second connection 104.

For example, the reversing can be predetermined for the second clock signal being an odd-number clock signal (or an even-number clock signal) transmitted on traces 182 on a printed circuit board 181.

For example, the first connection 102 and the second connection 104 are implemented via optical fibers 194 and 196 configured in ribbons that separate from the printed circuit board 181.

For example, the processor sub-system 101, the first memory sub-system 103, and the second memory sub-system 105 are mounted on a same printed circuit board 181.

For example, the first clock signal and the second clock signal are provided to the processor sub-system 101, the first memory sub-system 103, and the second memory sub-system 105 via traces 182 on the printed circuit board 181.

Optionally, the method of systolic memory access can include: transmitting a read command using the traces 182 on the printed circuit board 181 to receive the first data from the first memory sub-system 103; and transmitting a write command using the traces 182 on the printed circuit board 181 to write the second data 112 into the second memory sub-system 105.

Optionally, the method of systolic memory access can include: transmitting a first address using the traces 182 on the printed circuit board 181 to receive the first data from the first memory sub-system 103; and transmitting a second address using the traces 182 on the printed circuit board 181 to write the second data 112 into the second memory sub-system 105.

For example, the first memory sub-system 103, the second memory sub-system 105 and the processor sub-system 101 can each be implemented via a device having: one or more buffers (e.g., 158; or 157, . . . , 159); an optical receiver 153; an optical transmitter 151; and an optical connector 184. The optical connector 184 is operable to an optical fiber (e.g., 194 or 196) to the optical transmitter 151 through the optical receiver 153. The device can further include a controller 155 coupled to the one or more buffers (e.g., 158; or 157, . . . , 159) and configured to operate a combination of the optical receiver 153 and the optical transmitter 151 in either a transmission mode or a reception mode.

For example, the optical transmitter 151 is configured to modulate optical signals coming from a light source 169 toward the optical connector 184 in the transmission mode; and the optical receiver 154 is configured to detect optical signals propagating from the optical connector 184 toward the optical transmitter 151 in the reception mode.

Optionally, the optical receiver 153 is configured to detect optical signals coming from the optical transmitter 151 toward the optical connector 184 in the transmission mode; and the controller 155 is configured to detect transmission errors based on signals detected by the optical receiver 153 when the combination of the receiver 153 and the transmitter 151 is in the transmission mode.

Optionally, the optical transmitter is configured to attenuate optical signals passing through the optical transmitter 151 when the combination of the receiver 153 and the transmitter 151 in the reception mode.

For example, the device can include: a logic die 199 containing the controller 155; and an active interposer 186 containing the optical receiver 153, the optical transmitter 151, the optical connector 184, and wires configured to connect a ball grid array 187 to the logic die 199. The wires can go through the active interposer 186 without being connected to any of the optical receiver 153, and the optical transmitter 151.

Alternatively, the active interposer 186 can include the logic circuits of the controller 155 and optionally, the buffers (e.g., 157, . . . , 159; 158).

In some implementations, a non-transitory computer storage medium is configured to store instructions which, when executed in a computing device (e.g., as in FIG. 10), cause the computing device to perform a method, including compiling a program of a computation task 203 based on a transaction level model of a systolic processor 100 having the processor sub-system 101 connected to at least two separate memory sub-systems, such as the first memory sub-system 103 and the second memory sub-system 105. The method can further include: mapping, based on the compiling, memory addresses in the program of the computation task 203 to the two memory sub-systems 103 and 105; and generating instructions for the systolic processor 100 to read from the first memory sub-system 103 and write to the second memory sub-system 105 in a first set of predetermined clock cycles (e.g., T1, or odd-numbered clock cycles), and to write to the first memory sub-system 103 and read from the second memory sub-system 105 in a second set of predetermined clock cycles (e.g., T2, or even-numbered clock cycles). The first set of predetermined clock cycles and the second set of predetermined clock cycles are mutually exclusive.

Optionally, the method can further include: adding a memory sub-system differentiation bit 215 to a memory address (e.g., common portion 213) in the program of the computation task 203. When the memory sub-system differentiation bit 215 has a first value (e.g., zero), the memory address (e.g., common portion 213) is in the first memory sub-system 103. When the memory sub-system differentiation bit 215 has a second value (e.g., one), the memory address (e.g., common portion 213) is in the second memory sub-system 105. The systolic processor 100 can access either the first memory sub-system 103, or the second memory sub-system 105, according to the memory address (e.g., common portion 213) based on the value of the memory sub-system differentiation bit 215.

Optionally, the compiler 205 can configure instructions 207 to be executed by the processor sub-system 101 to generate the memory sub-system differentiation bit 215 for a memory address (e.g., common portion 213) used to access memory. When the memory sub-system differentiation bit 215 has a first value (e.g., zero), the memory address (e.g., common portion 213) is accessed by the processor sub-system 101 in the first memory sub-system 103; and when the memory sub-system differentiation bit 215 has a second value (e.g., one), the memory address (e.g., common portion 213) is accessed by the processor sub-system 101 in the second memory sub-system 105.

For example, memory access requests can be buffered in an optical interface module 128 of the processor sub-system 101 for communication with the memory sub-system 103 and 105 based on the timing of the communication directions of the connections 102 and 104, and the memory sub-system differentiation bit 215 attached to a memory address (e.g., common portion 213) that is accessible in both memory sub-systems 103 and 105.

At least some embodiments disclosed herein relate to hiding direct memory access (DMA) latency via dynamic memory services implemented using memory islands.

For example, a plurality of memory islands can be configured between a data storage facility and a processor sub-system 101. The data storage facility has a storage capacity that is significantly larger than the capacity of the memory islands. For example, the total storage capacity of the memory islands can be a small fraction of the size of the data stored in the data storage facility and used by the processor sub-system 101. However, the access speed of the memory islands is significantly faster than the data storage facility.

Optionally, a same memory address in a memory access request from the processor sub-system 101 can be mapped via a photonic interconnect to any of the memory islands. The processor sub-system 101 (or a processing element 141, . . . , 143, . . . , or 145) can be configured to repeat a same set of operations or a same routine for processing multiple batches of data in the storage.

A controller of the memory islands can be instructed to transfer data between the storage facility and one or more memory islands that are not actively being used by the processor sub-system 101. The data transfer can be performed during the time period in which the processor sub-system 101 is working on the previously fetched batch(es) of data in a slice of the memory offered by other memory islands. Thus, the data transfer has no impact on the operations of the processor sub-system 101.

When the processor sub-system 101 completes operations on a memory island, the control of the memory island can be transferred from the processor sub-system 101 to the controller of the memory islands. The controller can perform direct memory access (DMA) operations to transfer outputs from the memory island to the storage facility and to transfer a new batch of data to the memory island for subsequent processing by the processor sub-system 101.

When the controller of the memory islands completes the data transfer operations for a memory island, the control of the memory island can be transferred to the processor sub-system 101. For example, the memory island can be used as a substitute or a replacement of another memory island that has a previously loaded batch of data having been processed by the same set of operations (or the same routine) running in the processor sub-system 101.

By scheduling batches of data transfers between memory islands and the data storage facility during the time period of the processor sub-system 101 operating on other memory islands, the latency of accessing the data storage facility can be at least partially hidden from the processor sub-system 101.

Optionally, a photonic switch system can be used to implement the virtualization of the memory offered by the memory islands via the dynamic use of different wavelengths. For example, optical signals of a wavelength for the communications between the processor sub-system 101 and the memory islands can be configured as a virtual channel associated with a memory region. The memory region can be dynamically mapped to any of the memory islands via the connection of the virtual channel to a respective memory island.

For example, the memory sub-system 121 in FIG. 2 can be to have a plurality of memory islands, each having random access memories (e.g., 131, . . . , 133) operated by a respective memory controller (e.g., 123). A controller 155 of the optical interface circuit 127 or optical interface module 128 of the memory sub-system 121 can be configured to perform direct memory access (DMA) operations to transfer data between the memory island and a data storage facility (e.g., over a computer network or communication fabric).

For example, the processor sub-system 101 can provide the controller 155 of the optical interface circuit 127 or optical interface module 128 of the memory sub-system 121 with an identification of a sequence of batches of data that will be accessed by the processor sub-system 101. The controller 155 can identify the memory islands currently being used by the processor sub-system 101, and the memory islands that are not being sued by the processor sub-system 101 in a current time period. Based on the identification of data batches to be processed by the processor sub-system 101, the controller 155 can perform direct memory access (DMA) operations on the memory islands that are not currently being used by the processor sub-system 101. The memory island can be connected to the processor sub-system 101 when the memory island is are ready for the applications running in the processor sub-system 101.

Optionally, a memory island can dynamically join the subset of active memory islands that are connected via the photonic interconnect to the processor sub-system 101; and a memory island can be dynamically leave the subset of active memory islands. The photonic interconnect can dynamically adjust the allocation of communication bandwidths to the active memory islands based on the current memory access demands of the processor sub-system 101.

Optionally, the photonic interconnect is configured to perform dynamic swap of a memory island with another memory island. The memory island being swapped into the subset of active memory islands can provide a fresh set of inputs pre-loaded from the data storage facility; and the memory island being swapped out of the subset of active memory islands can provide the outputs previously generated by the processor sub-system 101.

In some implementations, the computing system is configured such that the time of loading a batch of inputs into a memory island and offloading a batch of outputs from a memory island is substantially the same as (or shorter than) the processing time of a batch of inputs for optimized computing performance of the processor sub-system 101.

As a result, the details of using the memory islands can be hidden from the processor sub-system 101. The processor sub-system 101 (or one or more processing elements (e.g., 141, . . . , 143) in the processor sub-system 101) can repeat the same operations of a routine that can be automatically applied to different batches of data.

Alternatively, memory virtualization techniques can be used in programming the processor sub-system 101 to access a slice of the memory offered by the memory islands for each batch of data.

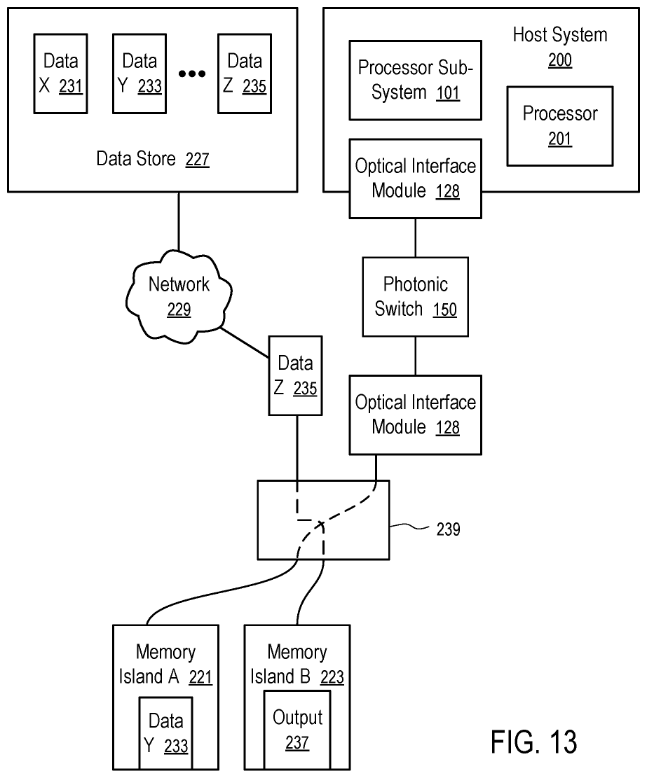

FIG. 11 shows a memory sub-system configured to provide a host system with access to a data store according to one embodiment. For example, the techniques of hiding direct memory access (DMA) discussed above can be implemented in the computing system of FIG. 11.

In FIG. 11, a host system 200 includes a processor 201 and/or a processor sub-system 101 (e.g., as in FIG. 3 and/or FIG. 10). The host system 200 is connected via a photonic interconnect to a memory sub-system 121. The photonic interconnect can include an optical interface module 128 connected to the host system 200, an optical interface module 128 connected to the memory sub-system 121, a photonic switch 150 configured between the optical interface modules 128, and optical fibers connected between the optical interface modules 128 and the photonic switch 150.

Optionally, the systolic memory access technique of FIG. 1 can also be used. For example, another photonic interconnect can be provided between the host system 200 and another memory sub-system such that the host system 200 is configured between the two memory sub-systems (e.g., as in FIG. 1 and/or FIG. 10).

In FIG. 11, the memory sub-system 121 is configured to have a plurality of memory islands 221, 223, . . . , 225. Each of the memory islands 221, 223, . . . , 225 can operate independently of other memory islands in the memory sub-system 121 and can be used to substitute the role of another memory island. Thus, the memory sub-system 121 can dynamically adjust the interconnect of the memory islands 221, 223, . . . , 225 for the applications running the host system 200 and for the direct memory access (DMA) operations with a data store 227.

For example, the data store 227 can be connected to the memory sub-system 121 via a network 229. A large amount of data (e.g., 231, 233, . . . , 235) (e.g., larger than the capacity of the memory sub-system 121) can be stored in the data store 227. The memory sub-system 121 has a capacity that is a fraction of the data (e.g., 231, 233, . . . , 235) in the data store 227.

The data (e.g., 231, 233, . . . , 235) in the data store can be pre-chunked for the applications running in the host system 200. A chunk of data (e.g., 231 or 233) can be sized to be fully loadable into a memory island (e.g., 221 or 223).

Optionally, a memory island (e.g., 221 or 223) is configured to have a capacity that is sufficient to store the output of the host system 200 generated from processing a data chunk (e.g., 231 or 233). Thus, after processing the chunk of data (e.g., 231 or 233) in a memory island (e.g., 221 or 223), the output of the processing can be stored by the host system 200 in the memory island (e.g., 221 or 223); and the controller 239 can be instructed to offload the output from the memory island (e.g., 221 or 223) into the data store 227. Alternatively, the output can be stored by the host system 200 in a memory island (e.g., 225) different from the memory island (e.g., 221) that provides the input data (e.g., 231) used to generate the output; and the controller 239 can write the data from the output memory island (e.g., 225) to the data store 227 when the output memory island (e.g., 225) is not being used by the host system 200.

In one example, a memory island (e.g., 221) is connected via the photonic interconnect to provide pre-loaded input data (e.g., 231); and the host system 200 can store the output generated from the input data (e.g., 231) in place in the same memory island (e.g., 221). In another example, a memory island (e.g., 221) is connected via the photonic interconnect to provide pre-loaded input data (e.g., 231); and one or more different memory islands (e.g., 223) can be connected via the photonic interconnect to provide the working memory in processing the input data (e.g., 231) and for storing the output.

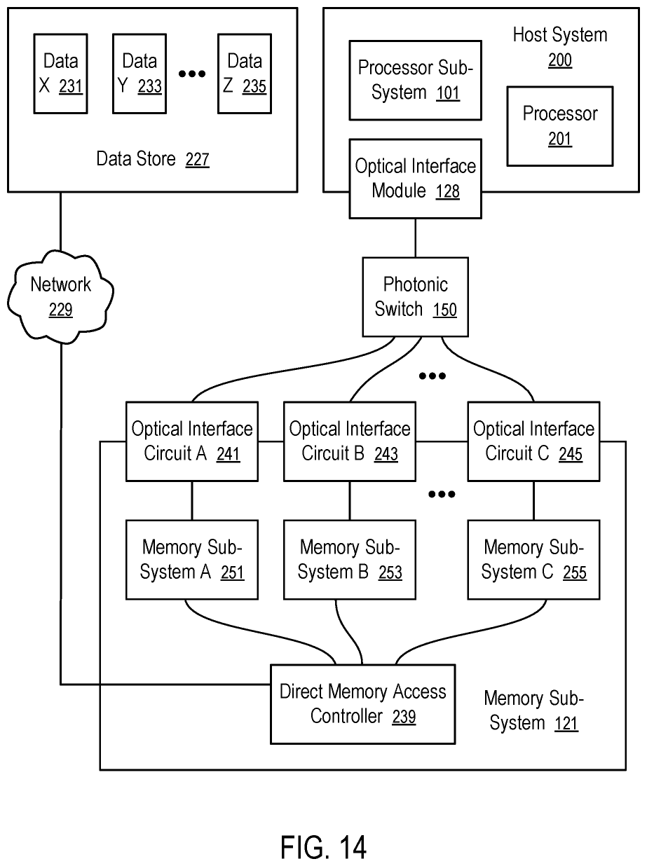

Optionally, the memory sub-system 121 can be configured with more memory islands 221, 223, . . . , 225 than what is to be used by the host system 200 concurrently for peak computing performance. Thus, the memory islands can be partitioned or grouped into two subsets: one active subset being connected via the photonic interconnect to the host system 200, and the other inactive subset being operated by the controller 239 to transfer data to or from the data store 227, as further illustrated in FIG. 12 and FIG. 13.

Optionally, the photonic interconnect can be replaced with a network of electric communication connections (e.g., configured to communicate according to a protocol standard for computer express link (CXL)).

FIG. 12 and FIG. 13 illustrate direct memory access operations of a memory sub-system according to one embodiment.

In FIG. 12, a memory island 223 has data 231 previously retrieved from the data store 227 over the network 229. The controller 239 configures the memory island 223 to be connected to the host system 200 via the photonic interconnect (e.g., optical interface modules 128 and the photonic switch 150). Thus, the host system 200 can access the data 231 in the memory island 223 at a high speed and low latency.

In FIG. 12, another memory island 221 is in an inactive subset that is not currently being used by the host system 200. Thus, the memory island 221 is not connected via the photonic interconnect to the host system 200; and the communication bandwidth of the photonic interconnect used by the active subset of memory islands is not affected by memory islands (e.g., 221) in the inactive subset. The controller 239 can perform direct memory access (DMA) operations to load another chunk of data 233 from the data store 227 over the network 229 into the memory island 221. The loading of the data 233 from the data store 227 does not go through the photonic interconnect to the host system 200.

Optionally, the host system 200 can send predetermined instructions of direct memory access (DMA) operations to the controller 239. The controller 239 can perform the direct memory access (DMA) operations when a memory island (e.g., 221) joins the inactive subset and thus becomes available for direct memory access (DMA) operations. The controller 239 can then perform the direct memory access (DMA) operations on the inactive memory island (e.g., 221) without impacting the performance of the host system 200 in accessing the active set of memory island (e.g., 223). As a result, the direct memory access (DMA) latency of loading the data 233 from the data store 227 can be hidden behind the time of processing of the data 231 in the memory island 223, with reduced or no impact on the computing performance of the host system 200.

In some instances, the memory island 221 has outputs generated by the host system 200 in processing a previous chunk of data (e.g., 235). Thus, the direct memory access (DMA) operations of the controller 239 performed for the memory island 221 can include storing the outputs from the memory island 221 to the data store 227.

After the completion of the direct memory access (DMA) operations for the memory island 221 and the processing of data 231 by the host system 200, the controller 239 can reconfigure the connections of the memory islands 221 and 223 as in FIG. 13. For example, the role of the memory island 223 in the active subset can be replaced by the memory island 221.

In FIG. 13, the memory island 221 has data 233 previously retrieved from the data store 227 over the network 229 as in FIG. 12. The controller 239 configures the memory island 221 to be connected to the host system 200 via the photonic interconnect (e.g., optical interface modules 128 and the photonic switch 150). Thus, the host system 200 can access the data 233 in the memory island 221 at a high speed and low latency. For example, the host system 200 can restart the routine to process the data 233 in a same way as processing the data 221 previously in the memory island 223 to generate the output 237.

In FIG. 13, the memory island 223 is now in the inactive subset that is not currently being used by the host system 200. Thus, the memory island 223 is not connected via the photonic interconnect to the host system 200. The controller 239 can perform direct memory access (DMA) operations to store the output 237, previously generated by the host system 200, into the data store 227 and to load another chunk of data (e.g., 235) from the data store 227 over the network 229 into the memory island 223.

For example, the host system 200 can send the predetermined instructions of direct memory access (DMA) operations to the controller 239. The controller 239 can queue the instructions for performance when a memory island (e.g., 223) is released by the host system 200 from the active subset. For example, when the host system 200 completes the processing of the data 231 in the memory island 223 and the generation of the output 237, the host system 200 can communicate an indication to the controller 239 to cause the controller 239 to disconnect the memory island 223 from the host system 200 for direct memory access (DMA) operations. Optionally, an instruction to offload the output 237 via direct memory access (DMA) operations can function as the indication to remove the memory island 223 from the active subset.

Optionally, after the memory island 221 is connected via the photonic interconnect to the host system 200, the controller 239 can report the completion status of loading the data 233 via direct memory access (DMA) operations. In response, the host system 200 can restart the routine to process the input data 233 (e.g., in the same way of previously processing the input data 231 in the memory island 223 in FIG. 12, as if the input data 233 were loaded into the memory island 223).

In some implementations, the memory address space used by the host system 200 is defined on the entire capacity of the collection of the memory islands 221, 223, . . . , 225 of the memory sub-system 121. The photonic interconnect between the host system 200 and the memory sub-system 121 is configured to render an active subset of the memory islands 221, 223, . . . , 225 accessible to the host system 200. The host system 200 can have different memory addresses used to address the memory islands (e.g., 221 and 223). When the host system 200 generates a memory access request to load data from or store data to a memory address that in the inactive subset of the memory islands 221, 223, . . . , 225, the controller 239 can generate an error response. Optionally, when a memory island (e.g., 221) is connected via the photonic interconnect to the host system 200, the controller 239 can provide an indication that the segment of memory addresses serviced by the memory island (e.g., 221) is ready to provide memory services.

In alternative implementations, the memory address space used by the host system 200 is defined on a predefined fraction of the entire capacity of the collection of the memory islands 221, 223, . . . , 225 of the memory sub-system 121. The same memory address space can be implemented using different portions of the memory islands 221, 223, . . . , 225. Thus, the same memory addresses used to access the memory island 223 can be used to access the memory island 221 when the role of the memory island 223 in the active subset is replaced by the memory island 221.

For example, the current active subset of memory islands (e.g., 223, . . . , 225) being connected via the photonic interconnect to the host system 200 can implement the entire memory address space used by the host system 200. The photonic interconnect can be configured to map the memory address space to the active subset of memory islands (e.g., 223, . . . , 225). When the host system 200 plans to use a new chunk of data (e.g., 233) from the data store 227 while processing the previously loaded data (e.g., 231 as in FIG. 12), the host system 200 can send an instruction of direct memory access (DMA) to the controller 239 to load the data (e.g., 233) into a region of memory addresses in the memory address space. Instead of performing on the direct memory access (DMA) operations in the memory island (e.g., 223) that is currently being used to implement the region of memory addresses (e.g., as in FIG. 12), the controller 239 is configured to execute the direct memory access (DMA) instruction by allocating a free memory island (e.g., 221) from the inactive subset, and pre-loading the data (e.g., 233) into the allocated memory island (e.g., 221 as in FIG. 12). Subsequently, when the pre-loaded chunk of data (e.g., 233) is ready for access in the allocated memory island (e.g., 221) and when the computation performed on the memory island 223 is complete, the controller 235 can substitute in the active subset the memory island 223, previously used to implement the memory address region, with the allocated memory island (e.g., 221) that has the pre-loaded data (e.g., 223) and that is configured to implement the same memory address region.

For example, after the host system 200 completes the processing of the data 231 in the memory island 221 and generates an output 237 in the memory island 221, the host system 200 can issue a direct memory access (DMA) instruction to offload, to the data store 227, the output 237 from the memory address region currently implemented using the memory island 221. The offload instruction can function as an indication that the computation based on the memory island 223 is complete. In response, the controller 239 can disconnect the memory island 223 from the host system 200 and connect the replacement memory island 221 having the pre-loaded data 233 to implement the same memory address region previously implemented on the memory island 223. Optionally, an alternative communication can be used by the host system 200 to indicate that the memory island 223 can be replaced with an alternative memory island (e.g., 221) that has pre-loaded data 233 in the same memory address region.

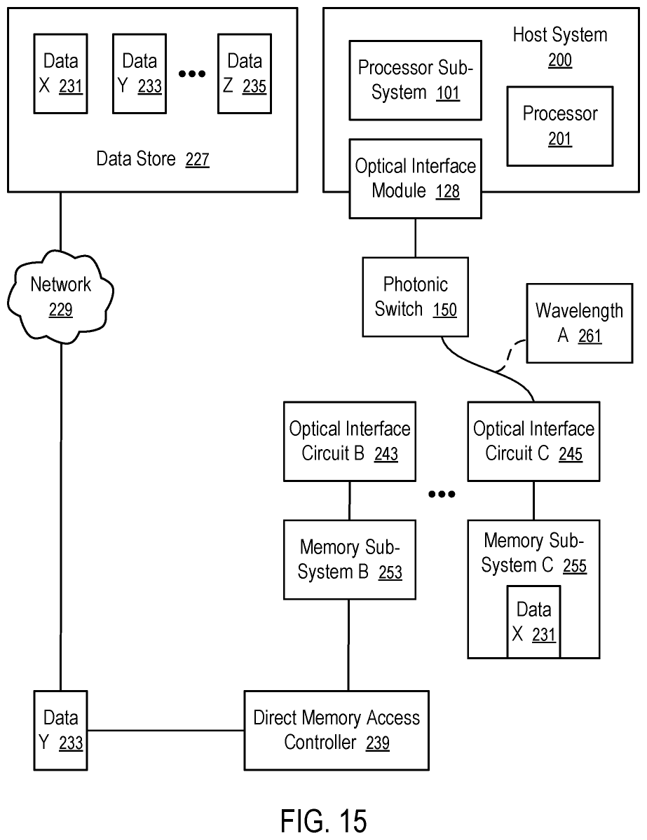

In some implementations, the optical interface module 128 of the memory sub-system 121 has a plurality of optical interface circuits 129 connected to the plurality of memory islands respectively. Each of the optical interface circuits 127 has an optical transmitter 151 and an optical receiver 153 (e.g., as in FIG. 4) that can communicate via optical signals of one or more wavelengths. The photonic interconnect can dynamically allocate virtual channels, represented by optical signals of different wavelengths, to optical interface circuits 127 of the memory islands 221 to route memory access requests according to memory address regions being accessed to the respective memory islands (e.g., 221 or 223), as in FIG. 14. For example, each memory island (e.g., 221, 223, . . . , 225) can be implemented via a memory sub-system having a memory controller (e.g., 123) and a plurality of random access memories (e.g., 131, . . . , 133).

Optionally, the virtual channels can be configured to communicate according to a protocol standard of computer express link (CXL).

FIG. 14 shows a photonic interconnect system configured between a host system and a direct memory access controller according to one embodiment. For example, the memory sub-system 121 of FIG. 11 can be implemented in a way as show in FIG. 14.

In FIG. 14, a plurality of memory sub-systems 251, 253, . . . , 255 are used to implement the memory islands 221, 223, . . . , 225 of FIG. 11. For example, each of the memory sub-systems 251, 253, . . . , 255 can be configured as a solid state drive, a hand bandwidth memory (HBM) module, etc. The memory sub-systems 251, 253, . . . , 255 can be configured on a same printed circuit board 181, or a set of printed circuit boards 181 mounted on a rack.

A plurality of optical interface circuits 241, 243, . . . , 245 are connected to the memory sub-systems 251, 253, . . . , 255 respectively. The communication bandwidth between the host system 200 and the memory sub-system 121 can be dynamically partitioned and allocated to the optical interface circuits 241, 243, . . . , 245, or an active subset of the optical interface circuits 241, 243, . . . , 245, via the routing of optical signals of different wavelengths.

For example, the propagation of optical signals on an optical path between the host system 200 and the memory sub-system 121 can provide a virtual channel for the host system 200 to communicate, via an optical interface circuit (e.g., 241), with a memory sub-system (e.g., 251) configured as a memory island (e.g., 221). The photonic switch 150 can be configured to route optical signals of one or more wavelengths to an optical interface circuit (e.g., 243) and thus allocate a portion of the communication bandwidth offered by the photonic interconnect to the respective memory sub-system (e.g., 253). Optionally, the photonic switch 150 can be configured to prevent the propagation of optical signals of certain wavelengths to or from an optical interface circuit (e.g., 241) of a memory sub-system (e.g., 251). Alternatively, or in combination, the photonic interconnect can coordinate the use of selected wavelengths in optical transceivers 176 in a selected subsets of the optical interface circuits 241, 243, . . . , 245 in configuring the virtual channels.

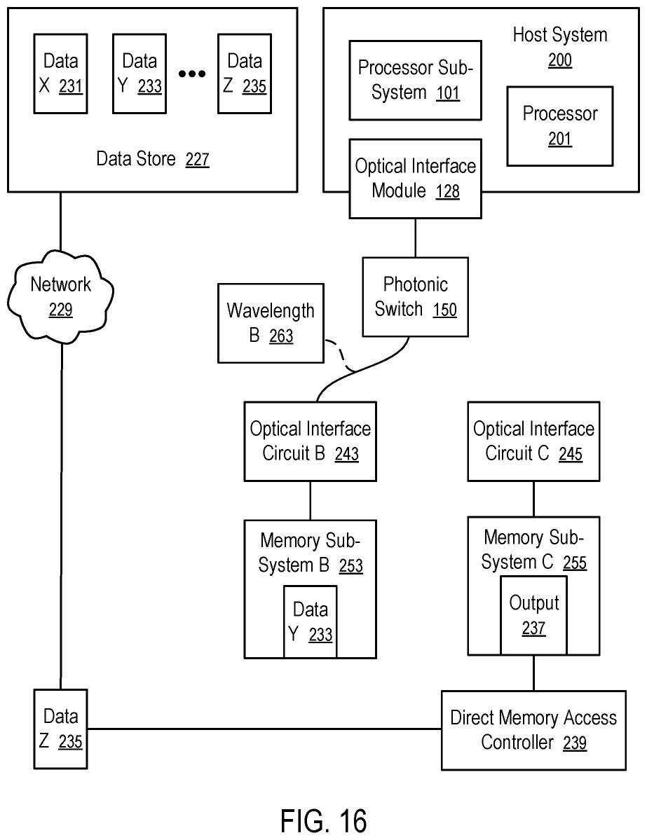

Through the dynamic allocation of the communication bandwidth of the photonic interconnect, the computing system of FIG. 14 can fully utilize the photonic interconnect in accessing an active subset of the memory sub-systems 251, 253, . . . , 255 to service the memory needs of the host system 200 in running applications. At the same time, a direct memory access controller 239 can be configured to operate on an inactive subset of the memory sub-systems 251, 253, . . . , 255 to pre-load data from the data store 227 and store outputs into the data store, as further illustrated in FIG. 15 and FIG. 16.

FIG. 15 and FIG. 16 illustrate the operations of the photonic interconnect system of FIG. 14 during direct memory access according to one embodiment.

In FIG. 15, a memory sub-system 255 has data 231 previously retrieved by the direct memory access controller 239 over the network 229 from the data store 227. The optical interface circuit 245 connects a virtual channel of wavelength 261 between the memory sub-system 255 and the host system 200 via the photonic the photonic switch 150. Thus, the host system 200 can access the data 231 in the memory sub-system 255 using the virtual channel at a high speed and low latency.

For example, an optical transmitter 151 in the optical interface module 128 can modulate optical signals of the wavelength 261 to send access requests addressed to a memory region implemented in the memory sub-system 255. The photonic switch 150 routes the optical signals of the wavelength 261 to the optical interface circuit 245; and an optical receiver 153 and/or a photodetector 172 in the optical interface circuit 245 of the memory sub-system 255 can operate receive the access request from detection of the modulated optical signals of the wavelength 261.

In some implementations, the photonic switch 150 is configured to route optical signals of the wavelength 261 to the optical interface circuit 245 of the memory sub-system 255 but not to other optical interfaces (e.g., 243) of other memory sub-systems (e.g., 253). For example, the photonic switch 150 can include an arrayed waveguide grating (AWG) configured as an optical demultiplexer to route optical signals of the wavelength 261 to the optical interface circuit 245 but not the other optical interface circuits (e.g., 243).

Optionally, the optical signals of the wavelength 261 can propagate to multiple optical interface circuits (e.g., 245 and 243). The optical receiver 153 in the optical interface circuit 245 can be instructed to operate at the wavelength 261 to receive data, while other optical interface circuits (e.g., 243) are instructed not to operate at the wavelength 261.

when the memory sub-system 255 generates a response, the optical transmitter 151 in its optical interface circuit 245 can modulate optical signals of the wavelength 261 for propagation to the optical interface module 128 of the host system 200.

In FIG. 15, another memory sub-system 253 is in an inactive subset that is not currently being used by the host system 200. Thus, no virtual channel of optical communications is connected by the photonic interconnect from the memory sub-system 253 to the host system 200. Since the memory sub-system 253 is not being used by the host system 200, the direct memory access (DMA) controller 239 can perform operations to load another chunk of input data 233 from the data store 227 over the network 229 into the memory sub-system 253.

For example, the host system 200 can send predetermined direct memory access (DMA) instructions to the controller 239, based on scheduled workloads of the processor sub-system 101. The direct memory access (DMA) controller 239 can load the data 233 from the data store 227 into the memory sub-system 253 that is not be connected to the host system 200 via a virtual channel in the photonic interconnect. Thus, the direct memory access (DMA) operations performed by the controller 239 have no impact on the use of the active memory sub-systems (e.g., 255) that are connected via virtual channels (e.g., of wavelength 261) to the host system 200. The direct memory access (DMA) latency of loading the data 233 from the data store 227 can be hidden behind the time of processing of the data 231 in the memory sub-system 255.

In some instances, the memory sub-system 253 has the output generated by the host system 200 in processing a previous chunk of data (e.g., 235). Thus, the direct memory access (DMA) operations of the controller 239 performed for the memory sub-system 253 can include storing the output from the memory sub-system 253 to the data store 227.

After the completion of the direct memory access (DMA) operations for the memory sub-system 253 and/or the processing of data 231 by the host system 200, the photonic interconnect can reconfigure the virtual channels for the memory sub-systems 253 and 255 (e.g., as in FIG. 16).

In FIG. 16, the memory sub-system 253 has data 233 previously retrieved from the data store 227 over the network 229 (e.g., as in FIG. 15). The photonic interconnect allocates a virtual channel of wavelength 263 to connect the optical interface circuit 243 of the memory sub-system 253 to the host system 200. Thus, the host system 200 can access the data 233 in and the memory capacity of the memory sub-system 253 at a high speed and low latency.

In FIG. 16, the memory sub-system 255 is now in an inactive subset that is not currently being used by the host system 200. Thus, no virtual channel is allocated in the photonic interconnect for the optical interface circuit 245. Thus, the memory sub-system 255 is effectively disconnected by the photonic interconnect from the host system 200. The controller 239 can perform direct memory access (DMA) operations to store the output 237, previously generated by the host system 200, into the data store 227 and to load a further chunk of input data 235 from the data store 227 over the network 229 into the memory sub-system 255.

For example, the host system 200 can send a direct memory access (DMA) instruction to the controller 239. In response to a determination that the direct memory access (DMA) operations of the instruction are configured to load data 233 into a memory address region implemented in the memory sub-system 255, the controller 239 allocates a free memory sub-system 253 as a replacement of the memory sub-system 255 and loads the data 233 into memory sub-system 253, as in FIG. 15.

Subsequently, the host system 200 can send a further direct memory access (DMA) instruction to the controller 239. In response to a determination that the direct memory access (DMA) operations of the instruction are configured to store output 237 from the memory address region implemented in the memory sub-system 255, the controller 239 can cause the switch of roles of the memory sub-system 253 and the memory sub-system 255 in the active subset. As a result of the switching, the memory sub-system 253 is connected to the host system via a virtual channel of a wavelength 263 as in FIG. 16; and the memory sub-system 255 is disconnected from the host system 200.

In general, the wavelength 263 allocated to the memory sub-system 253 in FIG>16 can be the same wavelength 261 previously used by the optical interface circuit 245 of the memory sub-system 255, or a different wavelength. For example, an allocation map can be used to specify which wavelengths are used for which memory address regions; and the allocation map can change based on the intensity of memory accesses in different address regions.

The memory sub-system 253 contains the data 233 loaded according to previously direct memory access (DMA) instructions from the host system 200. Once the memory sub-system 253 is connected to the host system 200 via the virtual channel of the wavelength 263, the controller 239 can send a response to the host system 200 to indicate the completion of the instruction for loading the data 233 via the direct memory access (DMA) operations. In response, the host system 200 can start accessing and processing the data 233.

Since the memory sub-system 255 is now disconnected from the host system 200 and replaced by the memory sub-system 253, the direct memory access (DMA) controller 239 can offload the output 237 to the data store 227 without impacting the operations of the host system 200 in processing the data 233. After completion of offloading the output 237, the memory sub-system 255 can become a free memory resource that can be allocated as a replacement of the memory sub-system 255 (or another memory sub-system 255) to download a further chunk of data from the data store 227 in execution of a direct memory access (DMA) instruction from the host system 200.

FIG. 15 and FIG. 16 illustrate virtual channels of wavelengths 261 and 263 for the optical interface circuits 245 and 243. In general, the photonic interconnect can allocate more than one virtual channel to a memory sub-system at a time. Based on the access demands of the host system 200, different numbers of virtual channels can be connected to different memory sub-systems in different time periods.

Optionally, the optical interface module 128 of the host system can also have a plurality of optical interface circuits connected to the plurality of processing elements 141, . . . , 143, . . . , 145 respectively. Virtual channels of different wavelengths can be dynamically configured between a pair of a processing element (e.g., 141) and a memory sub-system (e.g., 251) currently being mapped to implement a memory address being accessed by the processing element (e.g., 141).

In general, the direct memory access (DMA) controller 239 can also be used to move data between sections of memory sub-systems (e.g., 251 and 253). Thus, the direct memory access (DMA) operations are not limited to move data to or from the data store 227.

Optionally, the photonic switch 150 can include an optical demultiplexer (e.g., implemented using arrayed waveguide grating (AWG)) configured to separate optical signals of different wavelengths into different optical paths connected to the optical interface circuits 241, 243, . . . , 245 of the memory sub-systems 251, 253, . . . , 225. When each optical path is configured to receive optical signals of a single wavelength, a photodetector 172 can be used to receive data without using microring resonators (e.g., 171, or 173) in the optical receivers 153.

Similarly, transmission can be configured to operate using separate light sources of different wavelengths; and the photonic switch 150 can include an optical multiplexer (e.g., implemented using waveguide grating (AWG)) configured to combine optical signals of different wavelengths into a single optical path (e.g., for propagation over an optical fiber (e.g., 194 or 196) in the optical interconnect system).

Optionally, the optical fiber connected to each of the optical interface circuits (e.g., 241) can be used to carry optical signals of multiple wavelengths; and the optical transceiver 176 in the optical interface circuit (e.g., 241) can be instructed to operate using selected wavelengths. Optionally, the photonic switch 150 can be omitted; and an optical fiber can be used to connect the optical signals from the optical interface module 128 of the host system to the optical interface circuits 241, 243, . . . , 245 of the memory sub-system 121 (e.g., in a string configuration).

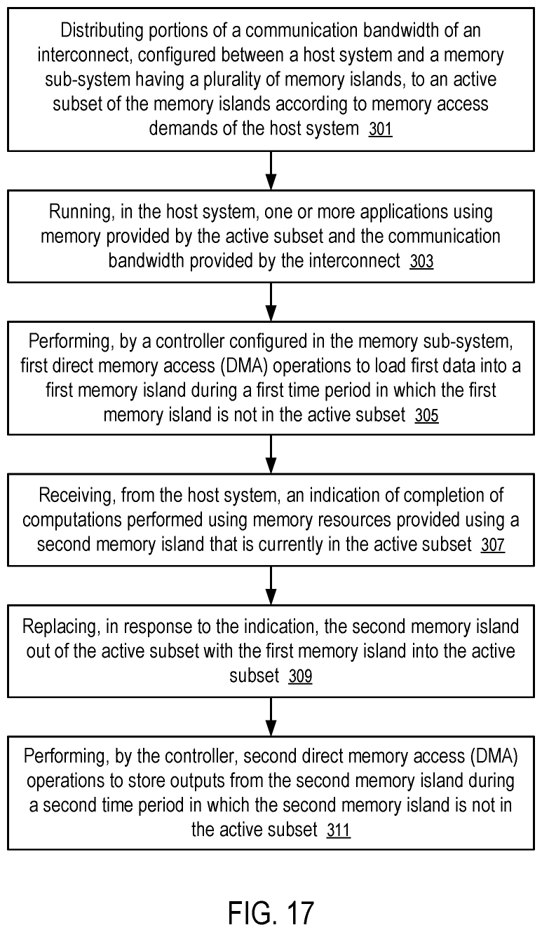

FIG. 17 shows a method of memory access management according to some embodiments.

For example, the method of FIG. 17 can be implemented in a computing system of FIG. 11 or FIG. 14 using the techniques of hiding direct memory access (DMA) latency illustrated in FIG. 12, FIG. 13, FIG. 15 and FIG. 16. Optionally, the computing system of FIG. 11 or FIG. 14 can be further augmented with the systolic memory access of FIG. 1. Optionally, the photonic interconnect in the computing system of FIG. 11 or FIG. 14 can be implemented using optical interface circuits (e.g., 129 of FIG. 4) and optical interface modules (e.g., 128 of FIG. 5) configured according to FIG. 6, FIG. 7, and/or, FIG. 8 or FIG. 9.

For example, the computing system can include a host system 200, a memory sub-system 121 having a plurality of memory islands 221, 223, . . . , 225 and a direct memory access controller 239; and an interconnect configured between the host system 200 and the memory sub-system 121 to provide a communication bandwidth. The memory islands 221, 223, . . . , 225 can be implemented as memory sub-systems 251, 253, . . . , 225. The interconnect can be configured to allocate portions of the communication bandwidth to an active subset of the plurality of memory islands 221, 223, . . . 225. The direct memory access (DMA) controller 239 can be configured to perform direct memory access (DMA) operations on memory islands of the memory sub-system 121 but outside of the active subset. For example, the interconnect can include a photonic interconnect having optical interface modules 128, optical interface circuits (e.g., 241, 243, . . . , 245), and a photonic switch 150. For example, the photonic switch 150 can include at least an optical demultiplexer or an optical multiplexer, implemented using an arrayed waveguide grating (AWG).

At block 301, the method of memory access management includes distributing portions of a communication bandwidth of an interconnect, configured between a host system 200 and a memory sub-system 121 having a plurality of memory islands 221, 223, 225, to an active subset of the memory islands according to memory access demands of the host system.

For example, the distributing of the portions of the communication bandwidth of the interconnect can include connecting different virtual channels, implemented via optical signals of different wavelengths (e.g., 261, 263), from respective memory islands in the active subset to the host system 200.

For example, more virtual channels can be connected to the optical interface circuit 245 of the memory island implemented using the memory sub-system 255 when there are more memory access demand for the memory island than other memory islands in the active subset.

For example, no virtual channels are connected from memory islands outside of the active subset to the host system.

Optionally, the connecting of the different virtual channels can include routing (e.g., via the photonic switch 150) the optical signals of the different wavelengths from the optical interface module 128 of the host system 200 to optical interface circuits (e.g., 245) of the respective memory islands in the active subset.

Optionally, the connecting of the different virtual channels can include instructing optical receivers 153 in optical interface circuits 129 of the respective memory islands in the active subset to use wavelengths of the different virtual channels.

Optionally, each of the different virtual channels can be configured to communicate in accordance with a protocol of computer express link (CXL).

At block 303, the method includes running, in the host system 200, one or more applications using memory provided by the active subset and the communication bandwidth provided by the interconnect.

At block 305, the method includes performing, by a controller 239 configured in the memory sub-system 121, first direct memory access (DMA) operations to load first data (e.g., 233) into a first memory island (e.g., 221 or memory sub-system 253) during a first time period in which the first memory island (e.g., 221 or memory sub-system 253) is not in the active subset.

For example, the first data (e.g., 233) can be loaded from a data store 227 over a network 229 into the first memory island (e.g., 221 or memory sub-system 253) while the first memory island (e.g., 221 or memory sub-system 253) is outside of the active subset and thus does not consume the bandwidth and/or other resources of the interconnect.

At block 307, the method includes receiving, from the host system 200, an indication of completion of computations performed using memory resources provided using a second memory island (e.g., 223 or memory sub-system 255) that is currently in the active subset.

At block 309, the method includes replacing, in response to the indication, the second memory island (e.g., 223 or memory sub-system 255) out of the active subset with the first memory island (e.g., 221 or memory sub-system 253) into the active subset.

For example, the indication can include a direct memory access (DMA) instruction, from the host system 200 to the controller 239, to store the outputs 237 from a memory address region implemented by the second memory island (e.g., 223 or memory sub-system 255) over a network 229 into a data store 227; and the indication is generated while the second memory island (e.g., 223 or memory sub-system 255) is in the active subset.

For example, the second memory island (e.g., 223 or memory sub-system 255) is in the active subset during the first time period (e.g., as in FIG. 12 and FIG. 15) and configured to implement a memory address region. The replacing of the second memory island (e.g., 223 or memory sub-system 255) with the first memory island (e.g., 221 or memory sub-system 253) can include replacing implementation of the memory address region by the second memory island (e.g., 223 or memory sub-system 255) with implementation of the memory address region by the first memory island (e.g., 221 or memory sub-system 253).

At block 311, the method includes performing, by the controller 239, second direct memory access (DMA) operations to store outputs 237 from the second memory island (e.g., 223 or memory sub-system 255) during a second time period in which the second memory island (e.g., 223 or memory sub-system 255) is not in the active subset.

For example, the method can further include: receiving, in the controller 239 while the memory address region is being implemented by the second memory island (e.g., 223 or memory sub-system 255), a direct memory access (DMA) instruction to load the first data (e.g., 233) into the memory address region. In response, the controller 239 can allocate the first memory island (e.g., 221 or memory sub-system 253) as a replacement for the second memory island (e.g., 223 or memory sub-system 255), and perform the first direct memory access (DMA) operations. After the completion of the first direct memory access (DMA) operations, the controller 239 can postpone sending a response to the instruction until the replacing of the second memory island (e.g., 223 or memory sub-system 255) in the active subset in block 309. After the replacing of the second memory island (e.g., 223 or memory sub-system 255) with the first memory island (e.g., 221 or memory sub-system 253), the controller 239 can send a response to the direct memory access (DMA) instruction to the host system 200.

For example, after the replacing of the second memory island (e.g., 223 or memory sub-system 255) in the active subset in block 309, the controller 239 can perform second direct memory access (DMA) operations to load second data (e.g., 235) into the second memory island (e.g., 223 or memory sub-system 255) during the second time period in which the second memory island (e.g., 223 or memory sub-system 255) is not in the active subset.

For example, the host system 200 can schedule workloads of a plurality of processing elements 141, . . . , 143, . . . , 145 running one or more applications using memory provided by the active subset of memory islands having the first memory island (e.g., 221 or memory sub-system 253) that is not currently in the active subset and the second memory island (e.g., 223 or memory sub-system 255) that is currently in the active subset. For example, the scheduling can include the determination of which processing elements are to work on what tasks using which memory address regions. The tasks can include the processing of pre-chunked data 231, 233, . . . , 235 in the data store 227 as inputs to generate outputs (e.g., 237).

Based on the scheduling, the host system 200 can send to the direct memory access controller 239, a first instruction to load first data 233 into the memory address region currently being implemented via the second memory island (e.g., 223 or memory sub-system 255) in the active subset. The first instruction can cause the direct memory access controller 239 to allocate the first memory island (e.g., 221 or memory sub-system 253) as a replacement of the second memory island (e.g., 223 or memory sub-system 255) and load the first data 233 from the data store 227 into the first memory island (e.g., 221 or memory sub-system 253) using the time period in which the first memory island (e.g., 221 or memory sub-system 253) is not in the active subset and thus not used by the host system 200.

After the host system 200 sends the indication of completion of computations performed using memory resources provided using the second memory island (e.g., 223 or memory sub-system 255), as in block 307, the computing system can replace, in implementation of the memory address region, the second memory island (e.g., 223 or memory sub-system 255) by the first memory island (e.g., 221 or memory sub-system 253). In response to the first memory island (e.g., 221 or memory sub-system 253) providing the first data 233 in the memory address region, the host system 200 can start, in the one or more applications, a routine in processing the first data 233 provided in the memory address region implemented using the first memory island (e.g., 221 or memory sub-system 253).

For example, the host system 200 can send, to the direct memory access controller 239, a second instruction to store outputs 237 generated by the one or more applications in the memory address region implemented using the second memory island (e.g., 223 or memory sub-system 255) to the data store.

For example, both the first instruction and the second instruction can be sent during a time period in which the second memory island (e.g., 223 or memory sub-system 255) is active in implementing the memory address region and the first memory island (e.g., 221 or memory sub-system 253) is outside of the active subset. The operations requested via the first instruction can be performed while the first memory island (e.g., 221 or memory sub-system 253) is outside of the active subset; and the operations requested via the second instructions can be performed while the second memory island (e.g., 223 or memory sub-system 255) is outside of the active subset.

For example, the host system 200 can be connected to the active subset via a photonic interconnect having virtual channels allocated to respective memory islands in the active subset but not the memory islands outside of the active subset.

In general, a memory sub-system can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The memory sub-system can be installed in a computing system to accelerate multiplication and accumulation applied to data stored in the memory sub-system. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems. In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of the firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
distributing portions of a communication bandwidth of an interconnect, configured between a host system and a memory sub-system having a plurality of memory islands, to an active subset of the memory islands according to memory access demands of the host system;
running, in the host system, one or more applications using memory provided by the active subset and the communication bandwidth provided by the interconnect;
performing, by a controller configured in the memory sub-system, first direct memory access (DMA) operations to load first data into a first memory island during a first time period in which the first memory island is not in the active subset;
receiving, from the host system, an indication of completion of computations performed using memory resources provided using a second memory island that is currently in the active subset;
replacing, in response to the indication, the second memory island out of the active subset with the first memory island into the active subset; and
performing, by the controller, second direct memory access (DMA) operations to store outputs from the second memory island during a second time period in which the second memory island is not in the active subset.

2. The method of claim 1, wherein the indication includes a direct memory access (DMA) instruction to store the outputs from a memory address region implemented by the second memory island; and the indication is generated while the second memory island is in the active subset.

3. The method of claim 1, wherein the second memory island is in the active subset during the first time period and configured to implement a memory address region; and the replacing of the second memory island with the first memory island includes replacing implementation of the memory address region by the second memory island with implementation of the memory address region by the first memory island.

4. The method of claim 3, further comprising:
receiving, in the controller while the memory address region is being implemented by the second memory island, a direct memory access (DMA) instruction to load the first data into the memory address region.

5. The method of claim 4, further comprising:
allocating, in response to the direct memory access (DMA) instruction, the first memory island as a replacement for the second memory island.

6. The method of claim 5, further comprising:
sending, by the controller, a response to the direct memory access (DMA) instruction after the replacing of the second memory island with the first memory island.

7. The method of claim 6, further comprising:
performing, by the controller configured in the memory sub-system, second direct memory access (DMA) operations to load second data into the second memory island during the second time period.

8. The method of claim 1, wherein the distributing of the portions of the communication bandwidth of the interconnect includes connecting different virtual channels, implemented via optical signals of different wavelengths, from respective memory islands in the active subset to the host system.

9. The method of claim 8, wherein no virtual channels are connected from memory islands outside of the active subset to the host system.

10. The method of claim 8, wherein the connecting of the different virtual channels includes routing the optical signals of the different wavelengths from the host system to optical interface circuits of the respective memory islands in the active subset.

11. The method of claim 8, wherein the connecting of the different virtual channels includes instructing optical receivers in optical interface circuits of the respective memory islands in the active subset to use wavelengths of the different virtual channels.

12. The method of claim 8, wherein each of the different virtual channels is configured to communicate in accordance with a protocol of computer express link (CXL).

13. A computing system, comprising:
a host system;
a memory sub-system having a plurality of memory islands and a direct memory access controller;
an interconnect configured between the host system and the memory sub-system and having a communication bandwidth;
wherein the interconnect is configured to allocate portions of the communication bandwidth to an active subset of the plurality of memory islands; and
wherein the direct memory access controller is configured to perform direct memory access operations on memory islands of the memory sub-system but outside of the active subset.

14. The computing system of claim 13, wherein the interconnect includes a photonic interconnect.

15. The computing system of claim 14, wherein the photonic interconnect includes a photonic switch having at least an optical demultiplexer or an optical multiplexer.

16. The computing system of claim 15, wherein the photonic switch is implemented using an arrayed waveguide grating (AWG).

17. A non-transitory computer storage medium storing instructions which when executed in a computing system, cause the computing system to perform a method, comprising:
scheduling workloads of a plurality of processing elements in a host system running one or more applications using memory provided by an active subset of a plurality of memory islands, the plurality of memory islands including a first memory island that is not currently in the active subset and a second memory island that is currently in the active subset;
sending, based on the scheduling and to a direct memory access controller, a first instruction to load first data into a memory address region currently being implemented via the second memory island in the active subset, causing the direct memory access controller to allocate the first memory island as a replacement of the second memory island and load the first data from a data store into the first memory island;
sending, from the host system, an indication of completion of computations performed using memory resources provided using the second memory island to cause replacement, in implementation of the memory address region, the second memory island by the first memory island; and
starting, in the one or more applications, a routine in processing the first data provided in the memory address region implemented using the first memory island.

18. The non-transitory computer storage medium of claim 17, wherein the method further comprises:
sending, to the direct memory access controller, a second instruction to store outputs generated by the one or more applications in the memory address region implemented using the second memory island to the data store.

19. The non-transitory computer storage medium of claim 18, wherein the first instruction and the second instruction are sent during a time period in which the second memory island is active in implementing the memory address region and the first memory island is outside of the active subset.

20. The non-transitory computer storage medium of claim 19, wherein the host system is connected to the active subset via a photonic interconnect having virtual channels allocated to respective memory islands in the active subset.
